(19) United States
(12) Patent Application Publication
(10) Pub. No.: US 2020/0360907 A1
(43) Pub. Date: Nov. 19, 2020

(54) A PROCESS FOR PREPARING A ZEOLITIC MATERIAL HAVING A FRAMEWORK STRUCTURE TYPE RTH

(71) Applicant: BASF SE, Ludwigshafen am Rhein (DE)

(72) Inventors: Robert MCGUIRE, Florham Park, NJ (US); Ulrich MUELLER, Ludwigshafen (DE); Xiangju MENG, Hangzhou (CN); Feng-Shou XIAO, Hangzhou (CN)

(73) Assignee: BASF SE, Ludwigshafen am Rhein (DE)

(21) Appl. No.: 16/963,058

(22) PCT Filed: Jan. 22, 2019
(86) PCT No.: PCT/CN2019/072687

§ 371 Date: Jul. 17, 2020

(30) Foreign Application Priority Data
Feb. 6, 2018 (CN) PCT/CN2018/075433

(51) Int. Cl. B01J 29/76; C01B 39/48; C01B 39/02; B01J 35/10; B01J 37/00; B01J 37/03; B01J 37/30; B01J 37/08; B01D 53/94

(52) U.S. Cl. CPC B01J 29/76; B01D 2255/9205; C01B 39/026; B01J 35/1019; B01J 35/1023; B01J 35/1038; B01J 35/1042; B01J 37/0018; B01J 37/031; B01J 37/30; B01J 37/08; B01D 53/9418; C01P 2006/12; C01P 2006/14; C01P 2002/72; C01P 2004/03; C01P 2002/88; C01P 2002/86; B01J 2229/38; B01J 2229/186; B01D 2255/50; C01B 39/48

(57) ABSTRACT

A process for preparing a zeolitic material having a framework structure type RTH and having a framework structure comprising a tetravalent element Y, a trivalent element X and oxygen, said process comprising (i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2, 6-dimethylpyridinium cation containing compound; (ii) subjecting the mixture obtained in (i) to hydrothermal crystallization conditions, obtaining the zeolitic material having a framework structure type RTH

A process for preparing a zeolitic material having a framework structure type RTH

The present invention relates to a process for preparing a zeolitic material having a framework structure type RTH and having a framework structure comprising a tetravalent element Y, a trivalent element X and oxygen. Further, the present invention relates to a zeolitic material having a framework structure type RTH and having a framework structure comprising a tetravalent element Y, a trivalent element X and oxygen, obtainable or obtained by said process, and further relates to the use of said zeolitic material as a catalytically active material, as a catalyst, or as a catalyst component.

Zeolitic materials having a framework structure type RTH are known to be potentially effective as catalysts or catalyst components in industrial applications, for example for converting nitrogen oxides (NOx) in an exhaust gas stream and for converting methanol-to-olefin (MTO). Synthetic RTH zeolitic materials may generally be produced by using organic templates.

Greg S. Lee et al., “Polymethylated [4.11] Octanes Leading to Zeolite SSZ_50”, Journal of Solid State Chemistry 167, p. 289-298 (2002), describes a synthesis of such zeolitic materials which uses N-ethyl-N-methyl-5,7,7-trimethyl-azoniumbi-cyclo[4.1.1] octane cation as an organic template. However, this synthesis is expensive and accordingly not viable for wide applications.

Further, Joel E. Schmidt et al., “Facile preparation of Aluminosilicate RTH across a wide composition range using a new organic structure-directing agent”, Chemistry of Materials (ACS Publications) 26, p. 7099-7105 (2014), discloses the synthesis of RTH zeolitic material which uses imidazolium cations, and in particular pentamethylimidazolium, as an organic template and US 2017/0050858 A1 discloses a method for preparing zeolitic materials having a framework structure type RTH which uses 2,6-dimethyl-1-aza-spiro[5.4]decane cation as an organic template. However, the crystallization duration of these syntheses is of at least one day to 46 days.

Therefore, it was an object of the present invention to provide a process for preparing a zeolitic material having a framework structure type RTH and having a framework structure comprising a tetravalent element Y, a trivalent element X and oxygen which permits to reduce crystallization duration and being cost effective.

Surprisingly, it was found that the process for preparing a zeolite material having a framework structure RTH according to the present invention permits to reduce the duration of the process, in particular the crystallization duration, and to obtain zeolitic material having a framework structure type RTH with high aluminum content.

Therefore, the present invention relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound;
(ii) subjecting the mixture obtained in (i) to hydrothermal crystallization conditions, obtaining the zeolitic material having a framework structure type RTH; wherein Y is one or more of Si, Sn, Ti, Zr, and Ge;

wherein X is one or more of Al, B, In, and Ga.

Preferably the N-methyl-2,6-dimethylpyridinium cation containing compound is a salt, more preferably one or more of a halide, preferably iodide, chloride, fluoride and/or bromide, more preferably iodide, and a hydroxide, wherein more preferably the N-methyl-2,6-dimethylpyridinium cation containing compound is a hydroxide.

Preferably, the tetravalent element Y is Si.

Preferably, the trivalent element X is one or more of Al and B, more preferably Al. More preferably, Y is Si and X is Al.

It is preferred that the zeolitic material provided in (i) and having a framework structure type FAU is a zeolitic material selected from the group consisting of faujasite, zeolite Y, zeolite X, LSZ-210, US Y, and a mixture of two or more thereof, more preferably selected from the group consisting of zeolite Y, zeolite X and a mixture thereof, more preferably zeolite Y.

In the framework structure of the zeolitic material provided in (i), the molar ratio of Y:X, calculated as YO₂: X₂O₃, is preferably in the range of from 5:1 to 100:1, more preferably in the range of from 10:1 to 50:1, more preferably in the range of 13:1 to 30:1, more preferably in the range of 18:1 to 28:1, more preferably in the range of from 20:1 to 27:1.

Preferably, in the synthesis mixture in (i), the molar ratio of H₂O relative to Y, calculated as H₂O:YO₂, is in the range of from 2:1 to 80:1, more preferably in the range of from 3:1 to 50:1, more preferably in the range of from 3.5: 1 to 48: 1. More preferably, in the synthesis mixture in (i), the molar ratio of H₂O relative to Y, calculated as H₂O:YO₂, is in the range of from 4: 1 to 45: 1. Alternatively, more preferably, in the synthesis mixture in (i), the molar ratio of H₂O relative to Y, calculated as H₂O:YO₂, is in the range of from 3.5:1 to 6:1, more preferably in the range of from 4:1 to 5:1. Alternatively, more preferably, in the synthesis mixture in (i), the molar ratio of H₂O relative to Y, calculated as H₂O:YO₂, is in the range of from 15:1 to 20:1, more preferably in the range of from 17:1 to 19:1. As a further alternative, more preferably, in the synthesis mixture in (i), the molar ratio of H₂O relative to Y, calculated as H₂O:YO₂, is in the range of from 30:1 to 48:1, more preferably in the range of from 40:1 to 46:1, more preferably in the range of from 43:1 to 45:1.

In the synthesis mixture in (i), the molar ratio of the structure directing agent relative to Y, calculated as structure directing agent: YO₂, is preferably in the range of from 0.09:1 to 1:1, more preferably in the range of from 0.10:1 to 0.50:1, more preferably in the range of from 0.10: 1 to 0.42: 1. More preferably, in the synthesis mixture in (i), the molar ratio of the structure directing agent relative to Y, calculated as structure directing agent: YO₂, is in the range of from 0.13: 1 to 0.37: 1. Alternatively, more preferably, in the synthesis mixture in (i), the molar ratio of the structure directing agent relative to Y, calculated as structure directing agent: YO₂, is in the range of from 0.10:1 to 0.18:1, more preferably in the range of from 0.12:1 to 0.16:1, more preferably in the range of from 0.13:1 to 0.15:1. Alternatively, more preferably in the synthesis mixture in (i), the molar ratio of the structure directing agent relative to Y, calculated as structure directing agent: YO₂, is in the range of from 0.15:1 to 0.28:1, more preferably in the range of from 0.18:1 to 0.24:1, more preferably in the range of from 0.20:1 to 0.22:1. As a further alternative, more preferably, in the synthesis mixture in (i), the molar ratio of the structure directing agent relative to Y, calculated as structure directing agent: YO₂, is in the range of from 0.30:1 to 0.42:1, more preferably in the range of from 0.33:1 to 0.39:1, more preferably in the range of from 0.35:1 to 0.37:1.

Therefore, the present invention preferably relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound, wherein the zeolitic material is a zeolitic material selected from the group consisting of faujasite, zeolite Y, zeolite X, LSZ-210, US Y, and a mixture of two or more thereof, more preferably selected from the group consisting of zeolite Y, zeolite X and a mixture thereof, more preferably zeolite Y;
(ii) subjecting the mixture obtained in (i) to hydrothermal crystallization conditions, obtaining the zeolitic material having a framework structure type RTH; wherein Y is Si; wherein X is Al;

wherein in the framework structure of the zeolitic material provided in (i), the molar ratio of Y:X, calculated as YO₂: X₂O₃, is in the range of from 5:1 to 100:1, more preferably in the range of from 10:1 to 50:1, more preferably in the range of 13:1 to 30:1, more preferably in the range of 18:1 to 28:1, more preferably in the range of from 20:1 to 27:1;

wherein in the synthesis mixture in (i), the molar ratio of H₂O relative to Y, calculated as H₂O:YO₂, is in the range of from 2:1 to 80:1, more preferably in the range of from 3:1 to 50:1, more preferably in the range of from 3.5: 1 to 48: 1; and wherein in the synthesis mixture in (i), the molar ratio of the structure directing agent relative to Y, calculated as structure directing agent: YO₂, is in the range of from 0.09:1 to 1:1, more preferably in the range of from 0.10:1 to 0.50:1, more preferably in the range of from 0.10: 1 to 0.42: 1.

In the context of the present invention, in the synthesis mixture in (i), the molar ratio of the source of a base relative to Y, calculated as a source of a base: YO₂, is preferably in the range of from 0.02:1 to 0.32:1, more preferably in the range of from 0.04:1 to 0.30:1, more preferably in the range of from 0.06:1 to 0.30: 1.

More preferably, in the synthesis mixture in (i), the molar ratio of the source of a base relative to Y, calculated as a source of a base: YO₂, is in the range of from 0.07: 1 to 0.30: 1. Alternatively, more preferably, in the synthesis mixture in (i), the molar ratio of the source of a base relative to Y, calculated as a source of a base: YO₂, is in the range of from 0.06:1 to 0.10:1, more preferably in the range of from 0.07:1 to 0.09:1. As an alternative, more preferably, in the synthesis mixture in (i), the molar ratio of the source of a base relative to Y, calculated as a source of a base: YO₂, is in the range of from 0.20:1 to 0.25:1, preferably in the range of from 0.21:1 to 0.23:1. As a further alternative, more preferably, in the synthesis mixture in (i), the molar ratio of the source of a base relative to Y, calculated as a source of a base: YO₂, is in the range of from 0.24:1 to 0.32:1, more preferably in the range of from 0.26:1 to 0.30:1.

It is preferred that the source of a base provided in (i) comprises, more preferably is, a hydroxide. More preferably, the source of a base provided in (i) comprises, more preferably is, one or more of an alkali metal hydroxide and an alkaline earth metal hydroxide, more preferably an alkali metal hydroxide, more preferably sodium hydroxide.

Preferably, from 95 to 100 weight-%, more preferably from 98 to 100 weight-%, more preferably from 99 to 100 weight-%, more preferably from 99.5 to 100 weight-% of the synthesis mixture consist of a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound.

Therefore, the present invention preferably relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound, wherein from 95 to 100 weight-%, more preferably from 98 to 100 weight-%, more preferably from 99 to 100 weight-%, more preferably from 99.5 to 100 weight-% of the synthesis mixture consist of a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound;
(ii) subjecting the mixture obtained in (i) to hydrothermal crystallization conditions, obtaining the zeolitic material having a framework structure type RTH;

wherein Y is Si; wherein X is Al;

wherein in the framework structure of the zeolitic material provided in (i), the molar ratio of Y:X, calculated as YO₂: X₂O₃, is in the range of from 5:1 to 100:1, more preferably in the range of from 10:1 to 50:1, more preferably in the range of 13:1 to 30:1, more preferably in the range of 18:1 to 28:1, more preferably in the range of from 20:1 to 27:1;

wherein in the synthesis mixture in (i), the molar ratio of H₂O relative to Y, calculated as H₂O:YO₂, is in the range of from 2:1 to 80:1, more preferably in the range of from 3:1 to 50:1, more preferably in the range of from 3.5: 1 to 48: 1;

wherein in the synthesis mixture in (i), the molar ratio of the structure directing agent relative to Y, calculated as structure directing agent: YO₂, is in the range of from 0.09:1 to 1:1, preferably in the range of from 0.10:1 to 0.50:1, more preferably in the range of from 0.10: 1 to 0.42: 1; and wherein in the synthesis mixture in (i), the molar ratio of the source of a base relative to Y, calculated as a source of a base: YO₂, is in the range of from 0.02:1 to 0.32:1, more preferably in the range of from 0.04:1 to 0.30:1, more preferably in the range of from 0.06: 1 to 0.30: 1.

According to the present invention, there is no specific restriction on how the synthesis mixture is prepared in (i). Preferably, preparing a synthesis mixture in (i) comprises
(i.1) preparing a mixture comprising a zeolitic material having a framework structure type FAU and having a framework structure comprising the tetravalent element Y, the trivalent element X and oxygen, water, and an RTH framework structure type directing agent comprising a N-methyl-2,6-dimethylpyridinium cation containing compound;
(i.2) adding a source of a base to the mixture obtained in (i.1), obtaining the synthesis mixture.

As to (i.1), preparing the mixture preferably comprises stirring the mixture at a temperature of the mixture in the range of from 16 to 35° C. for a duration in the range of from 0.5 to 6 hours, more preferably at a temperature of the mixture in the range of from 20 to 30° C. for a duration in the range of from 0.75 to 4 hours, more preferably at a temperature of the mixture in the range of from 20 to 30° C. for a duration in the range of from 1.5 to 2.5 hours.

As to (i.2), preparing the synthesis mixture preferably comprises stirring the synthesis mixture at a temperature of the synthesis mixture in the range of from 16 to 35° C. for a duration in the range of from 0.5 to 6 hours, more preferably at a temperature of the synthesis mixture in the range of from 20 to 30° C. for a duration in the range of from 0.75 to 4 hours, more preferably at a temperature of the synthesis mixture in the range of from 20 to 30° C. for a duration of 1.5 to 2.5 hours.

Preferably, the hydrothermal crystallization conditions according to (ii) comprise crystallization duration in the range of from 10 minutes to 20 hours.

Preferably, the hydrothermal crystallization conditions according to (ii) comprise a crystallization temperature in the range of from 100 to 280° C. More preferably, the hydrothermal crystallization conditions according to (ii) comprise a crystallization duration in the range of from 10 minutes to 20 hours and a crystallization temperature in the range of from 100 to 280° C.

According to a first aspect of the present invention, it is preferred that the hydrothermal crystallization conditions according to (ii) comprise a crystallization temperature in the range of from 100 to 160° C. and a crystallization duration in the range of from 1 to 20 hours, more preferably a crystallization temperature in the range of from 120 to 140° C. and a crystallization duration in the range of from 10 to 14 hours, more preferably a crystallization temperature in the range of from 120 to 140° C. and a crystallization duration in the range of from 11 to 13 hours.

Therefore, the present invention preferably relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound, wherein the zeolitic material is a zeolitic material selected from the group consisting of faujasite, zeolite Y, zeolite X, LSZ-210, US Y, and a mixture of two or more thereof, more preferably selected from the group consisting of zeolite Y, zeolite X and a mixture thereof, more preferably zeolite Y;
(ii) subjecting the mixture obtained in (i) to hydrothermal crystallization conditions, obtaining the zeolitic material having a framework structure type RTH;

wherein Y is Si; wherein X is Al;

wherein in the framework structure of the zeolitic material provided in (i), the molar ratio of Y:X, calculated as YO₂: X₂O₃, is in the range of from 5:1 to 100:1, more preferably in the range of from 10:1 to 50:1, more preferably in the range of 13:1 to 30:1, more preferably in the range of 18:1 to 28:1, more preferably in the range of from 20:1 to 27:1;

wherein in the synthesis mixture in (i), the molar ratio of H₂O relative to Y, calculated as H₂O:YO₂, is in the range of from 2:1 to 80:1, more preferably in the range of from 3:1 to 50:1, more preferably in the range of from 3.5: 1 to 48: 1; and wherein in the synthesis mixture in (i), the molar ratio of the structure directing agent relative to Y, calculated as structure directing agent: YO₂, is in the range of from 0.09:1 to 1:1, more preferably in the range of from 0.10:1 to 0.50:1, more preferably in the range of from 0.10: 1 to 0.42: 1;

wherein in the synthesis mixture in (i), the molar ratio of the source of a base relative to Y, calculated as a source of a base: YO₂, is in the range of from 0.02:1 to 0.32:1, more preferably in the range of from 0.04:1 to 0.30:1, more preferably in the range of from 0.06: 1 to 0.30: 1;

wherein the hydrothermal crystallization conditions according to (ii) comprise a crystallization temperature in the range of from 100 to 160° C. and a crystallization duration in the range of from 1 to 20 hours, more preferably a crystallization temperature in the range of from 120 to 140° C. and a crystallization duration in the range of from 10 to 14 hours, more preferably a crystallization temperature in the range of from 120 to 140° C. and a crystallization duration in the range of from 11 to 13 hours.

According to a second aspect of the present invention, it is preferred that the hydrothermal crystallization conditions according to (ii) comprise a crystallization temperature in the range of from 160 to 200° C. and a crystallization duration in the range of from 0.5 to 10 hours, more preferably a crystallization temperature in the range of from 170 to 190° C. and a crystallization duration in the range of from 1.5 to 4.5 hours, more preferably a crystallization temperature in the range of from 170 to 190° C. and a crystallization duration of 2 to 4 hours.

Therefore, the present invention preferably relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound, wherein the zeolitic material is a zeolitic material selected from the group consisting of faujasite, zeolite Y, zeolite X, LSZ-210, US Y, and a mixture of two or more thereof, more preferably selected from the group consisting of zeolite Y, zeolite X and a mixture thereof, more preferably zeolite Y;
(ii) subjecting the mixture obtained in (i) to hydrothermal crystallization conditions, obtaining the zeolitic material having a framework structure type RTH;

wherein Y is Si; wherein X is Al;

wherein in the framework structure of the zeolitic material provided in (i), the molar ratio of Y:X, calculated as YO₂: X₂O₃, is in the range of from 5:1 to 100:1, more preferably in the range of from 10:1 to 50:1, more preferably in the range of 13:1 to 30:1, more preferably in the range of 18:1 to 28:1, more preferably in the range of from 20:1 to 27:1;

wherein in the synthesis mixture in (i), the molar ratio of H₂O relative to Y, calculated as H₂O:YO₂, is in the range of from 2:1 to 80:1, more preferably in the range of from 3:1 to 50:1, more preferably in the range of from 3.5: 1 to 48: 1; and wherein in the synthesis mixture in (i), the molar ratio of the structure directing agent relative to Y, calculated as structure directing agent: YO₂, is in the range of from 0.09:1 to 1:1, more preferably in the range of from 0.10:1 to 0.50:1, more preferably in the range of from 0.10: 1 to 0.42: 1;

wherein in the synthesis mixture in (i), the molar ratio of the source of a base relative to Y, calculated as a source of a base: YO₂, is in the range of from 0.02:1 to 0.32:1, more preferably in the range of from 0.04:1 to 0.30:1, more preferably in the range of from 0.06: 1 to 0.30: 1;

wherein the hydrothermal crystallization conditions according to (ii) comprise a crystallization temperature in the range of from 160 to 200° C. and a crystallization duration in the range of from 0.5 to 10 hours, more preferably a crystallization temperature in the range of from 170 to 190° C. and a crystallization duration in the range of from 1.5 to 4.5 hours, more preferably a crystallization temperature in the range of from 170 to 190° C. and a crystallization duration of 2 to 4 hours.

According to a third aspect of the present invention, it is preferred that the hydrothermal crystallization conditions according to (ii) comprise a crystallization temperature in the range of from 200 to 280° C. and a crystallization duration in the range of from 10 minutes to 3 hours, more preferably a crystallization temperature in the range of from 220 to 260° C. and a crystallization duration in the range of from 20 minutes to 90 minutes, more preferably a crystallization temperature in the range of from 220 to 260° C. and a crystallization duration in the range of from 30 to 70 minutes, more preferably a crystallization temperature in the range of from 220 to 260° C. and a crystallization duration in the range of from 40 to 60 minutes, wherein more preferably the hydrothermal crystallization conditions according to (ii) comprise a crystallization temperature in the range of from 230° C. to 250° C. and a crystallization duration in the range of from 45 to 55 minutes.

Therefore, the present invention preferably relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound, wherein the zeolitic material is a zeolitic material selected from the group consisting of faujasite, zeolite Y, zeolite X, LSZ-210, US Y, and a mixture of two or more thereof, more preferably selected from the group consisting of zeolite Y, zeolite X and a mixture thereof, more preferably zeolite Y;
(ii) subjecting the mixture obtained in (i) to hydrothermal crystallization conditions, obtaining the zeolitic material having a framework structure type RTH;

wherein Y is Si; wherein X is Al;

wherein in the framework structure of the zeolitic material provided in (i), the molar ratio of Y:X, calculated as YO₂: X₂O₃, is in the range of from 5:1 to 100:1, more preferably in the range of from 10:1 to 50:1, more preferably in the range of 13:1 to 30:1, more preferably in the range of 18:1 to 28:1, more preferably in the range of from 20:1 to 27:1;

wherein in the synthesis mixture in (i), the molar ratio of H₂O relative to Y, calculated as H₂O:YO₂, is in the range of from 2:1 to 80:1, more preferably in the range of from 3:1 to 50:1, more preferably in the range of from 3.5: 1 to 48: 1; and wherein in the synthesis mixture in (i), the molar ratio of the structure directing agent relative to Y, calculated as structure directing agent: YO₂, is in the range of from 0.09:1 to 1:1, more preferably in the range of from 0.10:1 to 0.50:1, more preferably in the range of from 0.10: 1 to 0.42: 1;

wherein in the synthesis mixture in (i), the molar ratio of the source of a base relative to Y, calculated as a source of a base: YO₂, is in the range of from 0.02:1 to 0.32:1, more preferably in the range of from 0.04:1 to 0.30:1, more preferably in the range of from 0.06: 1 to 0.30: 1;

wherein the hydrothermal crystallization conditions according to (ii) comprise a crystallization temperature in the range of from 200 to 280° C. and a crystallization duration in the range of from 10 minutes to 3 hours, more preferably a crystallization temperature in the range of from 220 to 260° C. and a crystallization duration in the range of from 20 minutes to 90 minutes, more preferably a crystallization temperature in the range of from 220 to 260° C. and a crystallization duration in the range of from 30 to 70 minutes, more preferably a crystallization temperature in the range of from 220 to 260° C. and a crystallization duration in the range of from 40 to 60 minutes, wherein more preferably the hydrothermal crystallization conditions according to (ii) comprise a crystallization temperature in the range of from 230° C. to 250° C. and a crystallization duration in the range of from 45 to 55 minutes.

According to the present invention, it is preferred that during the hydrothermal crystallization conditions according to (ii), the mixture obtained in (i) and subjected to (ii) is not stirred, more preferably not mechanically agitated, more preferably not agitated.

According to (ii) subjecting the synthesis mixture obtained in (i) to hydrothermal crystallization conditions is preferably carried out under autogenous pressure, more preferably in an autoclave.

Preferably, the process of the present invention further comprises
(iii) cooling the mixture obtained from (ii), more preferably to a temperature in the range of from 10 to 50° C., more preferably in the range of from 20 to 30° C.

Preferably, the process of the present invention further comprises
(iv) separating the zeolitic material from the mixture obtained from (ii) or (iii).

If (iv) is performed, (iv) preferably comprises
(iv.1) subjecting the mixture obtained from (ii) or (iii), more preferably from (iii), to a solid-liquid separation method, more preferably comprising a filtration method;
(iv.2) more preferably washing the zeolitic material obtained from (iv.1);
(iv.3) drying the zeolitic material obtained from (iv.1) or (iv.2), more preferably from (iv.2).

As to (iv.2), the zeolitic material is preferably washed with water, more preferably with deionized water.

As to (iv.3), the zeolitic material is preferably dried in a gas atmosphere having a temperature in the range of from 80 to 120° C., more preferably in the range of from 90 to 110° C. More preferably, the zeolitic material is dried in a gas atmosphere having a temperature in the range of from 90 to 110° C. for a duration in the range of from 0.5 to 5 hours, more preferably the zeolitic material is dried in a gas atmosphere having a temperature in the range of from 90 to 110° C. in the range of from 1 to 3 hours, more preferably in the range of from 1.5 to 2.5 hours.

If (iv) is performed, the process of the present invention preferably further comprises
(v) calcining the zeolitic material obtained from (iv), more preferably from (iv.3), in a gas atmosphere.

If (v) is carried out, the zeolitic material is preferably calcined in a gas atmosphere having a temperature in the range of from 400 to 650° C., more preferably in the range of from 500 to 600° C.

If (v) is carried out, the zeolitic material is preferably calcined in a gas atmosphere for a duration in the range of from 2 to 6 hours, more preferably in the range of from 3 to 5 hours. More preferably, as to (v), the zeolitic material is calcined in a gas atmosphere having a temperature in the range of from 400 to 650° C., more preferably in the range of from 500 to 600° C., for a duration in the range of from 2 to 6 hours, more preferably in the range of from 3 to 5 hours.

Therefore, the present invention preferably relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound;
(ii) subjecting the mixture obtained in (i) to hydrothermal crystallization conditions, obtaining the zeolitic material having a framework structure type RTH;
(iii) cooling the mixture obtained from (ii), more preferably to a temperature in the range of from 10 to 50° C., more preferably in the range of from 20 to 30° C.;
(iv) separating the zeolitic material from the mixture obtained from (iii), comprising;
   (iv.1) subjecting the mixture obtained from (iii), to a solid-liquid separation method, more preferably comprising a filtration method;
   (iv.2) more preferably washing the zeolitic material obtained from (iv.1);
   (iv.3) drying the zeolitic material obtained from (iv.1) or (iv.2), more preferably from (iv.2);
(v) calcining the zeolitic material obtained from (iv.3), in a gas atmosphere;

wherein Y is one or more of Si, Sn, Ti, Zr, and Ge;

wherein X is one or more of Al, B, In, and Ga.

Alternatively, if (iv) is performed, the process of the present invention preferably further comprises
(vi) subjecting the zeolitic material obtained from (iv), more preferably from (iv.3) to ion-exchange conditions.

If (vi) is carried out, (vi) preferably comprises
(vi.1) subjecting the zeolitic material obtained from (iv), more preferably from (iv.3), to ion-exchange conditions comprising bringing a solution comprising ammonium ions in contact with the zeolitic material obtained from (iv), obtaining a zeolitic material having a framework structure type RTH in its ammonium form.

As to (vi.1), the solution comprising ammonium ions is preferably an aqueous solution comprising a dissolved ammonium salt, more preferably a dissolved inorganic ammonium salt, more preferably a dissolved ammonium nitrate.

As to (vi.1), the solution comprising ammonium ions has preferably an ammonium concentration in the range of from 0.10 to 3 mol/L, more preferably in the range of from 0.20 to 2 mol/L, more preferably in the range of from 0.5 to 1.5 mol/L.

As to (vi.1), the solution comprising ammonium ions is preferably brought in contact with the zeolitic material obtained from (iv) at a temperature of the solution in the range of from 50 to 110° C., more preferably in the range of from 60 to 100° C., more preferably in the range of from 70 to 90° C.

According to (vi.1), the solution comprising ammonium ions is preferably brought in contact with the zeolitic material obtained from (iv) for a period of time in the range of from 0.5 to 3.5 hours, more preferably in the range of from 1 to 3 hours, more preferably in the range of from 1.5 to 2.5 h. More preferably, the solution comprising ammonium ions is preferably brought in contact with the zeolitic material obtained from (iv) at a temperature of the solution in the range of from 50 to 110° C., more preferably in the range of from 60 to 100° C., more preferably in the range of from 70 to 90° C., for a period of time in the range of from 0.5 to 3.5 hours, more preferably in the range of from 1 to 3 hours, more preferably in the range of from 1.5 to 2.5 h.

According to the present invention, bringing the solution in contact with the zeolitic material according to (vi.1) preferably comprises one or more of impregnating the zeolitic material with the solution and spraying the solution onto the zeolitic material, more preferably impregnating the zeolitic material with the solution.

If (vi.1) is carried out, (vi) preferably comprises
(vi.2) calcining the zeolitic material in (vi.1) in a gas atmosphere, more preferably in a gas atmosphere having a temperature in the range of from 400 to 600° C. for a duration in the range of from 2 to 6 hours, obtaining the H-form of the zeolitic material.

According to the present invention, if (vi) is performed, (vi.1) and (vi.2) are preferably carried out at least once, more preferably twice.

If (vi.2) is carried out, (vi) preferably comprises
(vi.3) subjecting the zeolitic material obtained from (vi.2) to ion-exchange conditions comprising bringing a solution comprising ions of one or more transition metals, more preferably of one or more of Cu and Fe, more preferably Cu.

As to (vi.3), the solution comprising ions of one or more transition metals is preferably an aqueous solution comprising a dissolved salt of one or more transition metals, more preferably a dissolved organic copper salt, more preferably a dissolved copper acetate.

As to (vi.3), the solution comprising ions of one or more transition metals has preferably a transition metal concentration, more preferably a copper concentration, in the range of from 0.10 to 3 mol/L, more preferably in the range of from 0.20 to 2 mol/L, more preferably in the range of from 0.5 to 1.5 mol/L.

According to (vi.3), the solution comprising ions of one or more transition metals is preferably brought in contact with the zeolitic material obtained from (vi.2) at a temperature of the solution in the range of from 20 to 80° C., more preferably in the range of from 30 to 70° C., more preferably in the range of from 40 to 60° C.

According to (vi.3), the solution comprising ions of one or more transition metals is preferably brought in contact with the zeolitic material obtained from (vi.2) for a period of time in the range of from 0.5 to 3.5 hours, more preferably in the range of from 1.0 to 3.0 hours, more preferably in the range of from 1.5 to 2.5 hours. More preferably, according to (vi.3), the solution comprising ions of one or more transition metals is brought in contact with the zeolitic material obtained from (vi.2) at a temperature of the solution in the range of from 20 to 80° C., more preferably in the range of from 30 to 70° C., more preferably in the range of from 40 to 60° C., for a period of time in the range of from 0.5 to 3.5 hours, more preferably in the range of from 1.0 to 3.0 hours, more preferably in the range of from 1.5 to 2.5 hours.

If (vi.3) is carried out, (vi) preferably comprises
(vi.4) calcining the zeolitic material in (vi.3) in a gas atmosphere, more preferably in a gas atmosphere having a temperature in the range of from 400 to 600° C. for a duration in the range of from 2 to 6 hours.

If (vi.2) or (vi.4) is carried out, the process of the present invention preferably further comprises (vii) ageing the zeolitic material obtained in (vi.2), more preferably in (vi.4), in gas atmosphere.

As to (vii), ageing is preferably performed in gas atmosphere, more preferably in air, having a temperature in the range of from 600 to 900° C. for a duration in the range of from 14 to 18 hours, more preferably a temperature in the range of from 700 to 800° C. for a duration in the range of from 15 to 17 hours.

Therefore, the present invention preferably relates to a process for preparing a zeolitic material having a framework structure type RTH and having a framework structure comprising a tetravalent element Y, a trivalent element X and oxygen, said process comprising:
(i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound;
(ii) subjecting the mixture obtained in (i) to hydrothermal crystallization conditions, obtaining the zeolitic material having a framework structure type RTH;
(iii) cooling the mixture obtained from (ii), more preferably to a temperature in the range of from 10 to 50° C., more preferably in the range of from 20 to 30° C.;
(iv) separating the zeolitic material from the mixture obtained from (iii), comprising;
   (iv.1) subjecting the mixture obtained from (iii) to a solid-liquid separation method, more preferably comprising a filtration method;
   (iv.2) more preferably washing the zeolitic material obtained from (iv.1);
   (iv.3) drying the zeolitic material obtained from (iv.1) or (iv.2), more preferably from (iv.2);
(vi) subjecting the zeolitic material obtained from (iv.3) to ion-exchange conditions, comprising
   (vi.1) subjecting the zeolitic material obtained from (iv.3) to ion-exchange conditions comprising bringing a solution comprising ammonium ions in contact with the zeolitic material obtained from (iv.3), obtaining a zeolitic material having a framework structure type RTH in its ammonium form;
   (vi.2) calcining the zeolitic material in (vi.1) in a gas atmosphere, more preferably in a gas atmosphere having a temperature in the range of from 400 to 600° C. for a duration in the range of from 2 to 6 hours, obtaining the H-form of the zeolitic material;
   (vi.3) more preferably subjecting the zeolitic material obtained from (vi.2) to ion-exchange conditions comprising bringing a solution comprising ions of one or more transition metals, more preferably of one or more of Cu and Fe, more preferably Cu;
   (vi.4) more preferably calcining the zeolitic material in (vi.3) in a gas atmosphere, more preferably in a gas atmosphere having a temperature in the range of from 400 to 600° C. for a duration in the range of from 2 to 6 hours;
(vii) ageing the zeolitic material obtained in (vi.2), more preferably in (vi.4), in gas atmosphere;

wherein Y is one or more of Si, Sn, Ti, Zr, and Ge;

wherein X is one or more of Al, B, In, and Ga.

The present invention further relates to a process for preparing a molding comprising a zeolitic material obtained or obtainable by a process, for preparing a zeolitic material having a framework structure type RTH and having a framework structure comprising a tetravalent element Y, a trivalent element X and oxygen, according to the present invention and optionally a binder material.

Preferably, the process comprises
(a) preparing a mixture comprising the zeolitic material obtained or obtainable by a process for preparing a zeolitic material having a framework structure type RTH and having a framework structure comprising a tetravalent element Y, a trivalent element X and oxygen according to the present invention, and a source of a binder material;
(b) subjecting the mixture prepared according to (a) to shaping.

There is no particular restriction with respect to the source of binder material used in the mixture according to (a). Preferably, the source of a binder material is one or more of a source of graphite, silica, titania, zirconia, alumina, and a mixed oxide of two or more of silicon, titanium and zirconium.

According to (a), the mixture preferably further comprises one or more of a pasting agent and a pore forming agent.

Preferably, subjecting to shaping according to (b) comprises subjecting the mixture prepared according to (a) to spray-drying, to spray-granulation, to tableting or to extrusion, more preferably to tableting.

The present invention further relates to a process for preparing a molding comprising
(a.1) preparing a zeolitic material according to a process for preparing a molding comprising a zeolitic material obtained or obtainable by a process for preparing a zeolitic material having a framework structure type RTH and having a framework structure comprising a tetravalent element Y, a trivalent element X and oxygen according to the present invention;
(a.2) preparing a mixture comprising the zeolitic material obtained in (a.1) and a source of a binder material;
(b) subjecting the mixture prepared according to (a.2) to shaping.

There is no particular restriction with respect to the source of binder comprised in the mixture according to (a.2). Preferably, the source of a binder material is one or more of a source of graphite, silica, titania, zirconia, alumina, and a mixed oxide of two or more of silicon, titanium and zirconium.

Preferably, the mixture prepared according to (a) further comprises one or more of a pasting agent and a pore forming agent.

Preferably, subjecting to shaping according to (b) comprises subjecting the mixture prepared according to (a.2) to spray-drying, to spray-granulation, to tableting, or to extrusion.

According to the present invention, it is preferred that the gas atmosphere comprises, more preferably is, one or more of air, lean air, and oxygen, more preferably air.

The present invention further relates to a zeolitic material having a framework structure type RTH and having a framework structure which comprises a tetravalent element Y, a trivalent element X and oxygen, wherein Y is one or more of Si, Sn, Ti, Zr, and Ge and wherein X is one or more of Al, B, In, and Ga.

Preferably, the tetravalent element Y is Si and the trivalent element X is one or more of Al and B, more preferably X is Al.

Preferably, in the framework structure of the zeolitic material, the molar ratio of Y:X, calculated as a YO₂: X₂O₃, is in the range of from 2: 1 to 25:1, more preferably the molar ratio is in the range of from 2:1 to 24:1, more preferably of from 10:1 to 23:1, more preferably of from 15:1 to 21:1, more preferably in the range of from 15.5: 1 to 20: 1, more preferably of from 16:1 to 19:1.

Preferably, the zeolitic material of the present invention has a BET specific surface area, determined as described in Reference Example 1 b), in the range of from 100 to 800 m²/g, more preferably of from 300 to 700 m²/g, more preferably of from 400 to 600 m²/g, more preferably of from 500 to 600 m²/g.

Preferably, the zeolitic material of the present invention has a N₂ micropore volume, determined as described in Reference Example 1 b), in the range of from 0.05 to 0.60 cm³/g, more preferably of from 0.10 to 0.50 cm³/g, more preferably of from 0.15 to 0.35 cm³/g, more preferably of from 0.20 to 0.30 cm³/g.

Preferably, the zeolitic material of the present invention exhibits a cuboid morphology, determined as described in Reference Example 1 d), wherein the cubes having edges the longest of which more preferably having a length in the range of from 0.2 to 2 micrometer, more preferably of from 0.2 to 1.5 micrometer.

Preferably, the zeolitic material of the present invention has a crystallinity in the range of from 80 to 100%, more preferably of from 90 to 100%, more preferably of from 99 to 100%, more preferably of 100%, determined as described in Reference Example 1 a) and g).

Preferably, the zeolitic material of the present invention has an X-ray diffraction pattern comprising at least the following reflections:

| Diffraction angle 2theta/° [Cu K (alpha 1)] | Intensity (%) |
|---|---|
| 8.16 to 12.16 | 20 to 40 |
| 16.86 to 20.86 | 50 to 80 |
| 21.24 to 25.24 | 52 to 82 |
| 23.10 to 27.10 | 70 to 100 |
| 23.55 to 27.55 | 70 to 100 |
| 28.63 to 32.63 | 30 to 50 |

wherein 100% relates to the intensity of the maximum peak in the X-ray powder diffraction pattern, more preferably having an X-ray diffraction pattern comprising at least the following reflections:

| Diffraction angle 2theta/° [Cu K (alpha 1)] | Intensity (%) |
|---|---|
| 9.16 to 11.16 | 20 to 40 |
| 17.86 to 19.86 | 50 to 80 |
| 22.24 to 24.24 | 52 to 82 |
| 24.10 to 26.10 | 70 to 100 |
| 24.55 to 26.55 | 70 to 100 |
| 29.63 to 31.63 | 30 to 50 |

wherein 100% relates to the intensity of the maximum peak in the X-ray powder diffraction pattern.

It is preferred that the zeolitic material of the present invention additionally comprises one or more transition metals, more preferably one or more of Cu and Fe, more preferably Cu. More preferably, the elemental metal amount of the one or more transition metals, more preferably one or more of Cu and Fe, more preferably Cu, is in the range of from 0.5 to 6.0 weight-%, preferably in the range of from 1.0 to 5.0 weight-%, more preferably in the range of from 1.5 to 4.0 weight-%, more preferably in the range of from 2.0 to 3.5 weight-% based on the total weight of the zeolitic material, calculated as elemental Cu or Fe.

The zeolitic material of the present invention which preferably additionally comprises one or more transition metals, more preferably one or more of Cu and Fe, more preferably Cu, has more preferably a BET specific surface area, determined as described in reference Example 1 b), in the range of from 100 to 800 m²/g, more preferably from 300 to 700 m²/g, more preferably from 400 to 600 m²/g, more preferably from 450 to 550 m²/g.

The zeolitic material of the present invention which preferably additionally comprises one or more transition metals, more preferably one or more of Cu and Fe, more preferably Cu, has more preferably a N₂ micropore volume, determined as described in reference Example 1 b), in the range of from 0.05 to 0.60 cm³/g, preferably from 0.10 to 0.50 cm³/g, more preferably from 0.15 to 0.35 cm³/g, more preferably from 0.20 to 0.30 cm³/g.

The present invention further relates to a zeolitic material having a framework structure type RTH and having a framework structure which comprises a tetravalent element Y, a trivalent element X and oxygen, obtainable or obtained or preparable or prepared by a process for preparing a zeolitic material having a framework structure type RTH and having a framework structure comprising a tetravalent element Y, a trivalent element X and oxygen according to the present invention, wherein Y is one or more of Si, Sn, Ti, Zr, and Ge and wherein X is one or more of Al, B, In, and Ga.

Preferably, the tetravalent element Y is Si and the trivalent element X is one or more of Al and B, more preferably X is Al.

Preferably, in the framework structure of the zeolitic material obtained or obtainable by a process according to the present invention, the molar ratio of Y:X, calculated as a YO₂: X₂O₃, is in the range of from 2: 1 to 25:1, more preferably the molar ratio is in the range of from 2:1 to 24:1, more preferably of from 10:1 to 23:1, more preferably of from 15:1 to 21:1, more preferably in the range of from 15.5: 1 to 20: 1, more preferably of from 16:1 to 19:1.

Preferably, the zeolitic material of the present invention has a BET specific surface area, determined as described in Reference Example 1 b), in the range of from 100 to 800 m²/g, more preferably of from 300 to 700 m²/g, more preferably of from 400 to 600 m²/g, more preferably of from 500 to 600 m²/g.

Preferably, the zeolitic material of the present invention has a N₂ micropore volume, determined as described in Reference Example 1 b), in the range of from 0.05 to 0.60 cm³/g, more preferably of from 0.10 to 0.50 cm³/g, more preferably of from 0.15 to 0.35 cm³/g, more preferably of from 0.20 to 0.30 cm³/g.

Preferably, the zeolitic material of the present invention exhibits a cuboid morphology, determined as described in Reference Example 1 d), wherein the cubes having edges the longest of which more preferably having a length in the range of from 0.2 to 2 micrometer, more preferably of from 0.2 to 1.5 micrometer.

Preferably, the zeolitic material of the present invention has a crystallinity in the range of from 80 to 100%, more preferably of from 90 to 100%, more preferably of from 99 to 100%, more preferably of 100%, determined as described in Reference Example 1 a) and g).

Preferably, the zeolitic material of the present invention has an X-ray diffraction pattern comprising at least the following reflections:

| Diffraction angle 2theta/° [Cu K (alpha 1)] | Intensity (%) |
|---|---|
| 8.16 to 12.16 | 20 to 40 |
| 16.86 to 20.86 | 50 to 80 |
| 21.24 to 25.24 | 52 to 82 |
| 23.10 to 27.10 | 70 to 100 |
| 23.55 to 27.55 | 70 to 100 |
| 28.63 to 32.63 | 30 to 50 |

wherein 100% relates to the intensity of the maximum peak in the X-ray powder diffraction pattern, more preferably having an X-ray diffraction pattern comprising at least the following reflections:

| Diffraction angle 2theta/° [Cu K (alpha 1)] | Intensity (%) |
|---|---|
| 9.16 to 11.16 | 20 to 40 |
| 17.86 to 19.86 | 50 to 80 |
| 22.24 to 24.24 | 52 to 82 |
| 24.10 to 26.10 | 70 to 100 |
| 24.55 to 26.55 | 70 to 100 |
| 29.63 to 31.63 | 30 to 50 |

wherein 100% relates to the intensity of the maximum peak in the X-ray powder diffraction pattern.

It is preferred that the zeolitic material of the present invention additionally comprises one or more transition metals, more preferably one or more of Cu and Fe, more preferably Cu. More preferably, the elemental metal amount of the one or more transition metals, more preferably one or more of Cu and Fe, more preferably Cu, is in the range of from 0.5 to 6.0 weight-%, preferably in the range of from 1.0 to 5.0 weight-%, more preferably in the range of from 1.5 to 4.0 weight-%, more preferably in the range of from 2.0 to 3.5 weight-% based on the total weight of the zeolitic material, calculated as elemental Cu or Fe.

The zeolitic material of the present invention which preferably additionally comprises one or more transition metals, more preferably one or more of Cu and Fe, more preferably Cu, has more preferably a BET specific surface area, determined as described in reference Example 1 b), in the range of from 100 to 800 m²/g, more preferably from 300 to 700 m²/g, more preferably from 400 to 600 m²/g, more preferably from 450 to 550 m²/g.

The zeolitic material of the present invention which preferably additionally comprises one or more transition metals, more preferably one or more of Cu and Fe, more preferably Cu, has more preferably a N₂ micropore volume, determined as described in reference Example 1 b), in the range of from 0.05 to 0.60 cm³/g, more preferably from 0.10 to 0.50 cm³/g, more preferably from 0.15 to 0.35 cm³/g, more preferably from 0.20 to 0.30 cm³/g.

The present invention further relates to a use of a zeolitic material according to the present invention as a catalytically active material, as a catalyst, or as a catalyst component. Preferably, the use of said zeolitic material is for the selective catalytic reduction of nitrogen oxides in an exhaust gas stream of a diesel engine. Or, the use of said zeolitic material is preferably for converting methanol to one or more olefins.

The present invention further relates to a use of a molding obtained or obtainable by a process for preparing a molding according to the present invention as a catalyst, preferably for the selective catalytic reduction of nitrogen oxides in an exhaust gas stream of a diesel engine or preferably for converting methanol compounds to one or more olefins.

The present invention further relates to a method for selectively catalytically reducing nitrogen oxides in an exhaust gas stream of a diesel engine, said method comprising bringing said exhaust gas stream in contact with a molding, preferably obtained or obtainable by a process for preparing a molding according to the present invention, comprising the zeolitic material according to the present invention comprising one or more transition metals, more preferably one or more of Cu and Fe, more preferably Cu.

The present invention further relates to a method for converting methanol compounds to one or more olefins, said method comprising bringing said compounds in contact with a molding, preferably obtained or obtainable by a process for preparing a molding according to the present invention, comprising the zeolitic material according to the present invention comprising one or more transition metals, more preferably one or more of Cu and Fe, more preferably Cu.

The present invention further relates to a method for selectively catalytically reducing nitrogen oxides in an exhaust gas stream of a diesel engine, said method comprising preparing a zeolitic material having a framework structure type RTH and having a framework structure which comprises a tetravalent element Y, a trivalent element X, and oxygen obtained or obtainable by a process for preparing a zeolitic material having a framework structure type RTH and having a framework structure comprising a tetravalent element Y, a trivalent element X and oxygen according to the present invention, and bringing said exhaust gas stream in contact with a catalyst comprising said zeolitic material.

The present invention further relates to a catalyst, preferably for selectively catalytically reducing nitrogen oxides in an exhaust gas stream of a diesel engine, or preferably for catalytically converting methanol to one or more olefins, said catalyst comprising the zeolitic material according to the present invention comprising one or more transition metals, more preferably one or more of Cu and Fe, more preferably Cu.

The present invention is illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3 and 4”.
1. A process for preparing a zeolitic material having a framework structure type RTH and having a framework structure comprising a tetravalent element Y, a trivalent element X and oxygen, said process comprising:
   (i) preparing a synthesis mixture comprising a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound;
   (ii) subjecting the mixture obtained in (i) to hydrothermal crystallization conditions, obtaining the zeolitic material having a framework structure type RTH;
   wherein Y is one or more of Si, Sn, Ti, Zr, and Ge;
   wherein X is one or more of Al, B, In, and Ga.
2. The process of embodiment 1, wherein the N-methyl-2,6-dimethylpyridinium cation containing compound is a salt, preferably one or more of a halide, preferably iodide, chloride, fluoride and/or bromide, more preferably iodide, and a hydroxide, wherein more preferably the N-methyl-2,6-dimethylpyridinium cation containing compound is a hydroxide.
3. The process of embodiment 1 or 2, wherein Y is Si.
4. The process of any one of embodiments 1 to 3, wherein X is one or more of Al and B, preferably Al.
5. The process of any one of embodiments 1 to 4, wherein Y is Si and X is Al.
6. The process of any one of embodiments 1 to 5, wherein the zeolitic material provided in (i) and having a framework structure type FAU is a zeolitic material selected from the group consisting of faujasite, zeolite Y, zeolite X, LSZ-210, US Y, and a mixture of two or more thereof, preferably selected from the group consisting of zeolite Y, zeolite X and a mixture thereof, more preferably zeolite Y.
7. The process of any one of embodiments 1 to 6, wherein in the framework structure of the zeolitic material provided in (i), the molar ratio of Y:X, calculated as YO₂: X₂O₃, is in the range of from 5:1 to 100:1, preferably in the range of from 10:1 to 50:1, more preferably in the range of 13:1 to 30:1, more preferably in the range of 18:1 to 28:1, more preferably in the range of from 20:1 to 27:1.
8. The process of any one of embodiments 1 to 7, wherein in the synthesis mixture in (i), the molar ratio of H₂O relative to Y, calculated as H₂O:YO₂, is in the range of from 2:1 to 80:1, preferably in the range of from 3:1 to 50:1, more preferably in the range of from 3.5:1 to 48:1.
9. The process of embodiment 8, wherein in the synthesis mixture in (i), the molar ratio of

H₂O relative to Y, calculated as H₂O:YO₂, is in the range of from 3.5:1 to 6:1, preferably in the range of from 4:1 to 5:1.
10. The process of embodiment 8, wherein in the synthesis mixture in (i), the molar ratio of H₂O relative to Y, calculated as H₂O:YO₂, is in the range of from 15:1 to 20:1, preferably in the range of from 17:1 to 19:1.
11. The process of embodiment 8, wherein in the synthesis mixture in (i), the molar ratio of H₂O relative to Y, calculated as H₂O:YO₂, is in the range of from 30:1 to 48:1, preferably in the range of from 40:1 to 46:1, more preferably in the range of from 43:1 to 45:1.
12. The process of any one of embodiments 1 to 11, wherein in the synthesis mixture in (i), the molar ratio of the structure directing agent relative to Y, calculated as structure directing agent: YO₂, is in the range of from 0.09:1 to 1:1, preferably in the range of from 0.10:1 to 0.50:1, more preferably in the range of from 0.10: 1 to 0.42: 1.
13. The process of embodiment 12, wherein in the synthesis mixture in (i), the molar ratio of the structure directing agent relative to Y, calculated as structure directing agent: YO₂, is in the range of from 0.10:1 to 0.18:1, preferably in the range of from 0.12:1 to 0.16:1, more preferably in the range of from 0.13:1 to 0.15:1.
14. The process of embodiment 12, wherein in the synthesis mixture in (i), the molar ratio of the structure directing agent relative to Y, calculated as structure directing agent: YO₂, is in the range of from 0.15:1 to 0.28:1, preferably in the range of from 0.18:1 to 0.24:1, more preferably in the range of from 0.20:1 to 0.22:1.
15. The process of embodiment 12, wherein in the synthesis mixture in (i), the molar ratio of the structure directing agent relative to Y, calculated as structure directing agent: YO₂, is in the range of from 0.30:1 to 0.42:1, preferably in the range of from 0.33:1 to 0.39:1, more preferably in the range of from 0.35:1 to 0.37:1.
16. The process of any one of embodiments 1 to 15, wherein in the synthesis mixture in (i), the molar ratio of the source of a base relative to Y, calculated as a source of a base: YO₂, is in the range of from 0.02:1 to 0.32:1, preferably in the range of from 0.04:1 to 0.30:1, more preferably in the range of from 0.06: 1 to 0.30: 1.
17. The process of embodiment 16, wherein in the synthesis mixture in (i), the molar ratio of the source of a base relative to Y, calculated as a source of a base: YO₂, is in the range of from 0.06:1 to 0.10:1, preferably in the range of from 0.07:1 to 0.09:1.
18. The process of embodiment 16, wherein in the synthesis mixture in (i), the molar ratio of the source of a base relative to Y, calculated as a source of a base: YO₂, is in the range of from 0.20:1 to 0.25:1, preferably in the range of from 0.21:1 to 0.23:1.
19. The process of embodiment 16, wherein in the synthesis mixture in (i), the molar ratio of the source of a base relative to Y, calculated as a source of a base: YO₂, is in the range of from 0.24:1 to 0.32:1, preferably in the range of from 0.26:1 to 0.30:1.
20. The process of any one of embodiments 1 to 19, wherein the source of a base provided in (i) comprises, preferably is, a hydroxide.
21. The process of embodiment 20, wherein the source of a base provided in (i) comprises, preferably is, one or more of an alkali metal hydroxide and an alkaline earth metal hydroxide, preferably an alkali metal hydroxide, more preferably sodium hydroxide.
22. The process of any one of embodiments 1 to 21, wherein from 95 to 100 weight-%, preferably from 98 to 100 weight-%, more preferably from 99 to 100 weight-%, more preferably from 99.5 to 100 weight-% of the synthesis mixture consist of a zeolitic material having a framework structure type FAU and having a framework structure comprising the tetravalent element Y, the trivalent element X and oxygen, water, a source of a base, and an RTH framework structure type directing agent comprising a N-methyl-2,6-dimethylpyridinium cation containing compound.
23. The process of any one of embodiments 1 to 22, wherein preparing a synthesis mixture in
   (i) comprises
   (i.1) preparing a mixture comprising a zeolitic material having a framework structure type FAU and having a framework structure comprising the tetravalent element Y, the trivalent element X and oxygen, water, and an RTH framework structure type directing agent comprising a N-methyl-2,6-dimethylpyridinium cation containing compound;
   (i.2) adding a source of a base to the mixture obtained in (i.1), obtaining the synthesis mixture.
24. The process of embodiment 23, wherein preparing the mixture according to (i.1) comprises stirring the mixture at a temperature of the mixture in the range of from 16 to 35° C. for a duration in the range of from 0.5 to 6 hours, preferably at a temperature of the mixture in the range of from 20 to 30° C. for a duration in the range of from 0.75 to 4 hours, more preferably at a temperature of the mixture in the range of from 20 to 30° C. for a duration in the range of from 1.5 to 2.5 hours.
25. The process of embodiment 23 or 24, wherein preparing the synthesis mixture according to (i.2) comprises stirring the synthesis mixture at a temperature of the synthesis mixture in the range of from 16 to 35° C. for a duration in the range of from 0.5 to 6 hours, preferably at a temperature of the synthesis mixture in the range of from 20 to 30° C. for a duration in the range of from 0.75 to 4 hours, more preferably at a temperature of the synthesis mixture in the range of from 20 to 30° C. for a duration of 1.5 to 2.5 hours.
26. The process of any one of embodiments 1 to 25, wherein the hydrothermal crystallization conditions according to (ii) comprise a crystallization duration in the range of from 10 minutes to 20 hours.
27. The process of any one of embodiments 1 to 26, wherein the hydrothermal crystallization conditions according to (ii) comprise a crystallization temperature in the range of from 100 to 280° C.
28. The process of any one of embodiments 1 to 27, wherein the hydrothermal crystallization conditions according to (ii) comprise a crystallization temperature in the range of from 100 to 160° C. and a crystallization duration in the range of from 1 to 20 hours, preferably a crystallization temperature in the range of from 120 to 140° C. and a crystallization duration in the range of from 10 to 14 hours, more preferably a crystallization temperature in the range of from 120 to 140° C. and a crystallization duration in the range of from 11 to 13 hours.
29. The process of any one of embodiments 1 to 27, wherein the hydrothermal crystallization conditions according to (ii) comprise a crystallization temperature in the range of from 160 to 200° C. and a crystallization duration in the range of from 0.5 to 10 hours, preferably a crystallization temperature in the range of from 170 to 190° C. and a crystallization duration in the range of from 1.5 to 4.5 hours, more preferably a crystallization temperature in the range of from 170 to 190° C. and a crystallization duration of 2 to 4 hours.
30. The process of any one of embodiments 1 to 27, wherein the hydrothermal crystallization conditions according to (ii) comprise a crystallization temperature in the range of from 200 to 280° C. and a crystallization duration in the range of from 10 minutes to 3 hours, preferably a crystallization temperature in the range of from 220 to 260° C. and a crystallization duration in the range of from 20 minutes to 90 minutes, more preferably a crystallization temperature in the range of from 220 to 260° C. and a crystallization duration in the range of from 30 to 70 minutes, more preferably a crystallization temperature in the range of from 220 to 260° C. and a crystallization duration in the range of from 40 to 60 minutes, wherein more preferably the hydrothermal crystallization conditions according to (ii) comprise a crystallization temperature in the range of from 230° C. to 250° C. and a crystallization duration in the range of from 45 to 55 minutes.
31. The process of any one of embodiments 1 to 30, wherein during hydrothermal crystallization according to (ii), the mixture obtained in (i) and subjected to (ii) is not stirred, preferably not mechanically agitated, more preferably not agitated.
32. The process of any one of embodiments 1 to 31, wherein according to (ii) subjecting the synthesis mixture obtained in (i) to hydrothermal crystallization conditions is carried out under autogenous pressure, preferably in an autoclave.
33. The process of any one of embodiments 1 to 32 further comprising
   (iii) cooling the mixture obtained from (ii), preferably to a temperature in the range of from 10 to 50° C., more preferably in the range of from 20 to 30° C.
34. The process of any one of embodiments 1 to 33 further comprising
   (iv) separating the zeolitic material from the mixture obtained from (ii) or (iii).
35. The process of embodiment 34, wherein (iv) comprises
   (iv.1) subjecting the mixture obtained from (ii) or (iii), preferably from (iii), to a solid-liquid separation method, preferably comprising a filtration method;
   (iv.2) preferably washing the zeolitic material obtained from (iv.1);
   (iv.3) drying the zeolitic material obtained from (iv.1) or (iv.2), preferably from (iv.2).
36. The process of embodiment 35, wherein according to (iv.2), the zeolitic material is washed with water, preferably with deionized water.
37. The process of embodiment 35 or 36, wherein according to (iv.3), the zeolitic material is dried in a gas atmosphere having a temperature in the range of from 80 to 120° C., preferably in the range of from 90 to 110° C., wherein according to (iv.3), the zeolitic material is more preferably dried in a gas atmosphere having a temperature in the range of from 90 to 110° C. for a duration in the range of from 0.5 to 5 hours, more preferably the zeolitic material is dried in a gas atmosphere having a temperature in the range of from 90 to 110° C. in the range of from 1 to 3 hours, more preferably in the range of from 1.5 to 2.5 hours.
38. The process of any one of embodiments 34 to 37 further comprising
   (v) calcining the zeolitic material obtained from (iv), preferably from (iv.3), in a gas atmosphere.
39. The process of embodiment 38, wherein according to (v), the zeolitic material is calcined in a gas atmosphere having a temperature in the range of from 400 to 650° C., preferably in the range of from 500 to 600° C.
40. The process of embodiment 38 or 39, wherein according to (v), the zeolitic material is calcined in a gas atmosphere for a duration in the range of from 2 to 6 hours, preferably in the range of from 3 to 5 hours.
41. The process of any one of embodiments 34 to 37 further comprising
   (vi) subjecting the zeolitic material obtained from (iv), preferably from (iv.3) to ion-exchange conditions.
42. The process of embodiment 41, wherein (vi) comprises
   (vi.1) subjecting the zeolitic material obtained from (iv), preferably from (iv.3), to ion-exchange conditions comprising bringing a solution comprising ammonium ions in contact with the zeolitic material obtained from (iv), obtaining a zeolitic material having a framework structure type RTH in its ammonium form.
43. The process of embodiment 42, wherein the solution comprising ammonium ions according to (vi.1) is an aqueous solution comprising a dissolved ammonium salt, preferably a dissolved inorganic ammonium salt, more preferably a dissolved ammonium nitrate.
44. The process of embodiment 42 or 43, wherein the solution comprising ammonium ions according to (vi.1) has an ammonium concentration in the range of from 0.10 to 3 mol/L, preferably in the range of from 0.20 to 2 mol/L, more preferably in the range of from 0.5 to 1.5 mol/L.
45. The process of any one of embodiments 42 to 44, wherein according to (vi.1), the solution comprising ammonium ions is brought in contact with the zeolitic material obtained from (iv) at a temperature of the solution in the range of from 50 to 110° C., preferably in the range of from 60 to 100° C., more preferably in the range of from 70 to 90° C.
46. The process of any one of embodiments 42 to 45, wherein according to (vi.1), the solution comprising ammonium ions is brought in contact with the zeolitic material obtained from (iv) for a period of time in the range of from 0.5 to 3.5 hours, preferably in the range of from 1 to 3 hours, more preferably in the range of from 1.5 to 2.5 h.
47. The process of any one of embodiments 42 to 46, wherein bringing the solution in contact with the zeolitic material according to (vi.1) comprises one or more of impregnating the zeolitic material with the solution and spraying the solution onto the zeolitic material, preferably impregnating the zeolitic material with the solution.
48. The process of any one of embodiments 42 to 47, wherein (vi) comprises
   (vi.2) calcining the zeolitic material in (vi.1) in a gas atmosphere, preferably in a gas atmosphere having a temperature in the range of from 400 to 600° C. for a duration in the range of from 2 to 6 hours, obtaining the H-form of the zeolitic material.
49. The process of embodiment 48, wherein (vi.1) and (vi.2) are carried out at least once, preferably twice.
50. The process of embodiment 48 or 49, wherein (vi) comprises
   (vi.3) subjecting the zeolitic material obtained from (vi.2) to ion-exchange conditions comprising bringing a solution comprising ions of one or more transition metals, preferably of one or more of Cu and Fe, more preferably Cu.
51. The process of embodiment 50, wherein the solution comprising ions of one or more transition metals according to (vi.3) is an aqueous solution comprising a dissolved salt of one or more transition metals, preferably a dissolved organic copper salt, more preferably a dissolved copper acetate.
52. The process of embodiment 50 or 51, wherein the solution comprising ions of one or more transition metals according to (vi.3) has a transition metal concentration, preferably a copper concentration, in the range of from 0.10 to 3 mol/L, more preferably in the range of from 0.20 to 2 mol/L, more preferably in the range of from 0.5 to 1.5 mol/L.
53. The process of any one of embodiments 50 to 52, wherein according to (vi.3), the solution comprising ions of one or more transition metals is brought in contact with the zeolitic material obtained from (vi.2) at a temperature of the solution in the range of from 20 to 80° C., preferably in the range of from 30 to 70° C., more preferably in the range of from 40 to 60° C.
54. The process of any one of embodiments 50 to 53, wherein according to (vi.3), the solution comprising ions of one or more transition metals is brought in contact with the zeolitic material obtained from (vi.2) for a period of time in the range of from 0.5 to 3.5 hours, preferably in the range of from 1.0 to 3.0 hours, more preferably in the range of from 1.5 to 2.5 hours.
55. The process of any one of embodiments 50 to 54, wherein (vi) comprises
   (vi.4) calcining the zeolitic material in (vi.3) in a gas atmosphere, preferably in a gas atmosphere having a temperature in the range of from 400 to 600° C. for a duration in the range of from 2 to 6 hours.
56. The process of any one of embodiments 48, 49 and 55 further comprising
   (vii) ageing the zeolitic material obtained in (vi.2), preferably in (vi.4), in gas atmosphere.
57. The process of embodiment 56, wherein ageing in (vii) is performed in gas atmosphere, preferably in air, having a temperature in the range of from 600 to 900° C. for a duration in the range of from 14 to 18 hours, preferably a temperature in the range of from 700 to 800° C. for a duration in the range of from 15 to 17 hours.
58. A process for preparing a molding comprising a zeolitic material obtained or obtainable by a process according to any one of embodiments 1 to 55 and optionally a binder material.
59. The process of embodiment 58 comprising
   preparing a mixture comprising the zeolitic material obtained or obtainable by a process according to any one of embodiments 1 to 55, and a source of a binder material;
   subjecting the mixture prepared according to (a) to shaping.
60. The process of embodiment 59, wherein the source of a binder material is one or more of a source of graphite, silica, titania, zirconia, alumina, and a mixed oxide of two or more of silicon, titanium and zirconium.
61. The process of embodiment 59 or 60, wherein the mixture prepared according to (a) further comprises one or more of a pasting agent and a pore forming agent.
62. The process of any one of embodiments 59 to 61, wherein subjecting to shaping according to (b) comprises subjecting the mixture prepared according to (a) to spray-drying, to spray-granulation, to tableting or to extrusion, preferably to tableting.
63. A process for preparing a molding comprising
   (a.1) preparing a zeolitic material according to a process of any one of embodiments) to 55;
   (a.2) preparing a mixture comprising the zeolitic material obtained in (a.1) and a source of a binder material;
   (b) subjecting the mixture prepared according to (a.2) to shaping.
64. The process of embodiment 63, wherein the source of a binder material is one or more of a source of graphite, silica, titania, zirconia, alumina, and a mixed oxide of two or more of silicon, titanium and zirconium.
65. The process of embodiment 63 or 64, wherein the mixture prepared according to (a) further comprises one or more of a pasting agent and a pore forming agent.
66. The process of any one of embodiments 63 to 65, wherein subjecting to shaping according to (b) comprises subjecting the mixture prepared according to (a.2) to spray-drying, to spray-granulation, to tableting, or to extrusion.
67. The process of any one of embodiments 37 to 40, 48, 55 to 57, wherein the gas atmosphere comprises, preferably is, one or more of air, lean air, and oxygen, more preferably air.
68. A zeolitic material having a framework structure type RTH and having a framework structure which comprises a tetravalent element Y, a trivalent element X and oxygen, obtainable or obtained or preparable or prepared by a process according to any one of embodiments 1 to 55, wherein Y is one or more of Si, Sn, Ti, Zr, and Ge and wherein X is one or more of Al, B, In, and Ga.
69. The zeolitic material of embodiment 68, wherein Y is Si and X is one or more of Al and B, preferably X is Al.
70. The zeolitic material of embodiment 68 or 69, wherein in the framework structure of the zeolitic material obtained or obtainable by a process according to any one of embodiments 1 to 55, the molar ratio of Y:X, calculated as a YO₂: X₂O₃, is in the range of from 2: 1 to 25:1, preferably the molar ratio is in the range of from 2:1 to 24:1, more preferably of from 10:1 to 23:1, more preferably of from 15:1 to 21:1, more preferably in the range of from 15.5:1 to 20:1, more preferably of from 16:1 to 19:1.
71. The zeolitic material of any one of embodiments 68 to 70, having a BET specific surface area, determined as described in Reference Example 1 b), in the range of from 100 to 800 m²/g, preferably of from 300 to 700 m²/g, more preferably of from 400 to 600 m²/g, more preferably of from 500 to 600 m²/g.
72. The zeolitic material of any one of embodiments 68 to 71, having a N₂ micropore volume, determined as described in Reference Example 1 b), in the range of from 0.05 to 0.60 cm³/g, preferably of from 0.10 to 0.50 cm³/g, more preferably of from 0.15 to 0.35 cm³/g, more preferably of from 0.20 to 0.30 cm³/g.
73. The zeolitic material of any one of embodiments 68 to 72, exhibiting a cuboid morphology, determined as described in Reference Example 1 d), wherein the cubes having edges the longest of which preferably having a length in the range of from 0.2 to 2 micrometer, more preferably of from 0.2 to 1.5 micrometer.
74. The zeolitic material of any one of embodiments 68 to 73, having a crystallinity in the range of from 80 to 100% preferably of from 90 to 100%, more preferably of from 99 to 100%, more preferably of 100%, determined as described in Reference Example 1 a) and g).
75. The zeolitic material of any one of embodiments 68 to 74, having an X-ray diffraction pattern comprising at least the following reflections:

| Diffraction angle 2theta/° [Cu K (alpha 1)] | Intensity (%) |
|---|---|
| 8.16 to 12.16 | 20 to 40 |
| 16.86 to 20.86 | 50 to 80 |
| 21.24 to 25.24 | 52 to 82 |
| 23.10 to 27.10 | 70 to 100 |
| 23.55 to 27.55 | 70 to 100 |
| 28.63 to 32.63 | 30 to 50 |

wherein 100% relates to the intensity of the maximum peak in the X-ray powder diffraction pattern, preferably having an X-ray diffraction pattern comprising at least the following reflections:

| Diffraction angle 2theta/° [Cu K (alpha 1)] | Intensity (%) |
|---|---|
| 9.16 to 11.16 | 20 to 40 |
| 17.86 to 19.86 | 50 to 80 |
| 22.24 to 24.24 | 52 to 82 |
| 24.10 to 26.10 | 70 to 100 |
| 24.55 to 26.55 | 70 to 100 |
| 29.63 to 31.63 | 30 to 50 |

wherein 100% relates to the intensity of the maximum peak in the X-ray powder diffraction pattern.
76. The zeolitic material of any one of embodiments 68 to 75, additionally comprising one or more transition metals, preferably one or more of Cu and Fe, more preferably Cu.
77. The zeolitic material of embodiment 76, wherein the elemental metal amount of the one or more transition metals, preferably one or more of Cu and Fe, more preferably Cu, is in the range of from 0.5 to 6.0 weight-%, preferably in the range of from 1.0 to 5.0 weight-%, more preferably in the range of from 1.5 to 4.0 weight-%, more preferably in the range of from 2.0 to 3.5 weight-% based on the total weight of the zeolitic material, calculated as elemental Cu or Fe.
78. The zeolitic material of embodiment 76 or 77, preferably the zeolitic material obtained or obtainable by a process according to any one of embodiments 41 to 57, having a BET specific surface area, determined as described in reference Example 1 b), in the range of from 100 to 800 m²/g, preferably from 300 to 700 m²/g, more preferably from 400 to 600 m²/g, more preferably from 450 to 550 m²/g.
79. The zeolitic material of any one of embodiments 76 to 78, preferably the zeolitic material obtained or obtainable by a process according to any one of embodiments 41 to 57, having a N₂ micropore volume, determined as described in reference Example 1 b), in the range of from 0.05 to 0.60 cm³/g, preferably from 0.10 to 0.50 cm³/g, more preferably from 0.15 to 0.35 cm³/g, more preferably from 0.20 to 0.30 cm³/g.
80. Use of a zeolitic material according to any one of embodiments 68 to 79 as a catalytically active material, as a catalyst, or as a catalyst component.
81. The use of embodiment 80 for the selective catalytic reduction of nitrogen oxides in an exhaust gas stream of a diesel engine.
82. The use of embodiment 80 for converting methanol to one or more olefins.
83. Use of a molding obtained or obtainable by a process according to any one of embodiments 58 to 69 as a catalyst, preferably for the selective catalytic reduction of nitrogen oxides in an exhaust gas stream of a diesel engine or preferably for converting methanol compounds to one or more olefins.
84. A method for selectively catalytically reducing nitrogen oxides in an exhaust gas stream of a diesel engine, said method comprising bringing said exhaust gas stream in contact with a molding, preferably obtained or obtainable by a process according to embodiment 58 to 67, comprising the zeolitic material according to any one of embodiments 76 to 79.
85. A method for converting methanol compounds to one or more olefins, said method comprising bringing said compounds in contact with a molding, preferably obtained or obtainable by a process according to embodiment 58 to 67, comprising the zeolitic material according to any one of embodiments 76 to 79.
86. A method for selectively catalytically reducing nitrogen oxides in an exhaust gas stream of a diesel engine, said method comprising preparing a zeolitic material having a framework structure type RTH and having a framework structure which comprises a tetravalent element Y, a trivalent element X, and oxygen obtained or obtainable by a process according to any one of embodiments 1 to 55 and bringing said exhaust gas stream in contact with a catalyst comprising said zeolitic material.
87. A catalyst, preferably for selectively catalytically reducing nitrogen oxides in an exhaust gas stream of a diesel engine, or preferably for catalytically converting methanol to one or more olefins, said catalyst, comprising the zeolitic material according to any one of embodiments 76 to 79.

The present invention is further illustrated by the following examples, reference examples, and comparative examples.

### EXAMPLES

### Reference Example 1: Characterizations

a) X-ray powder diffraction (XRD) patterns were measured with Rigaku Ultimate VI X-ray diffractometer (40 kV, 40 mA) using Cu_{Kalpha} (lambda=1.5406 Angstrom).
b) The N₂ sorption isotherms at the temperature of liquid nitrogen were measured using Micromeritics ASAP 2020M and Tristar system for determining the BET specific surface area. The N₂ micropore volume is measured by BJH measurement.
c) The sample composition was determined by inductively coupled plasma (ICP) with a Perkin-Elmer 3300DV emission spectrometer.
d) Scanning electron microscopy (SEM) experiments were performed on Hitachi SU-1510 microscopes.
e) ²⁷A1, ²⁹Si, ¹³C MAS nuclear magnetic resonance (NMR) spectra were recorded on a Varian Infinity Plus 400 spectrometer and the chemical shifts were referenced to Al(H₂O)₆³⁺.
f) TG-DTA were recorded using Perkin-Elmer TGA 7 unit in air at a heating rate of 10 K/min in the temperature range from room temperature to 1000° C.
g) The crystallinity was measured by the intensity of the maximum peak in the X-ray powder diffraction pattern measured as in a), wherein 100% relates to the highest intensity of the sample which has highest intensity.

### Example 1: Preparation of a Zeolitic Material Having a Framework Structure Type RTH

a) Preparing an organic structure directing agent (SDA): N-methyl-2,6-dimethylpyridinium hydroxide

0.1 mol of 2,6-dimethyl-pyridine and 0.12 mol of iodomethane (CH₃I) was dissolved in 20 g of ethanol. The mixture was then heated to 80° C. (353 K) and stirred for 12 hours in a dark place. The solvent and the excess of iodomethane were removed using rotary evaporation and the product was washed with ether.

The structure was verified using ¹³C and ¹H NMR as shown in FIGS. 1 and 2, respectively.

Finally, the product was converted from the iodide form to the hydroxide form using anion exchange resin to obtain N-methyl-2,6-dimethylpyridinium hydroxide. 130 g of structure directing agent were obtained.
b) Preparing a zeolitic material having a framework structure type RTH

Materials:

| | |
|---|---|
| Zeolite Y powder having a molar ratio | 1 g |
| SiO₂:Al₂O₃ of 24:1 | |
| N-methyl-2,6-dimethylpyridinium hydroxide | 5.83 g |
| solution (0.6 mol · L⁻¹) | |
| NaOH powder | 0.15 g |

1 g of zeolite Y was mixed with 5.83 g of N-methyl-2,6-dimethylpyridinium hydroxide solution (0.6 mol·L⁻¹) and stirred at room temperature for 2 hours. Then, 0.15 g of NaOH was added. The synthesis mixture was stirred again at room temperature for 2 hours. The synthesis mixture composition was 0.11 Na₂O:0.21 SDA:1.0 SiO₂:0.04 Al₂O₃:17.8 H₂O. The term SiO₂ refers to the silicon comprised in the zeolite Y calculated as silica. The obtained mixture was then transferred in a Teflon-lined autoclave oven. The autoclave was sealed and the mixture crystallized at 130° C. under static state for 12 hours. After pressure release and cooling to room temperature, the obtained suspension was subjected to filtration. The filter cake was washed with deionized water and was then dried for 2 hours at a temperature of 100° C. 0.8 g of zeolitic material was obtained.

The SiO₂:Al₂O₃ molar ratio of the zeolitic material was of 17.6. The XRD patterns, determined as described in reference Example 1 a), of the dried zeolitic material show series of peaks associated with the RTH framework structure type, namely a peak at 10.16 2Theta, a peak at 18.86 2Theta, a peak at 23.24 2Theta, a peak at 25.10 2Theta, a peak at 25.55 2Theta and a peak at 30.63 2Theta, as shown in FIG. 3A. After calcination at 550° C. for 4 hours, the BET specific surface area was 576 m²/g, determined as described in Reference Example 1 b), and the N₂ micropore volume, determined as described in Reference Example 1 b), was 0.26 cm³/g. The low magnification SEM image (scale bar: 2 micrometers) of the respectively obtained fresh RTH zeolitic material, determined as described in Reference Example 1 d), shows very uniform crystal morphology as shown in FIG. 3C. The high magnification SEM image (scale bar: 500 nm) of the respectively obtained fresh RTH zeolitic material, determined as described in Reference Example 1 d), shows that the crystals are blocky and have a cuboid morphology with edges the longest having a length of about 500 nm, as shown in FIG. 3D. The crystallinity of the sample was of 100%, determined as described in Reference Example 1 g), as shown in FIG. 4.

c) Preparing the H-form of a zeolitic material having a framework structure type RTH

The zeolitic material obtained from b) is ion-exchanged with a 1M NH₄NO₃ solution at 80° C. for 2 hours and calcined at 550° C. for 4 hours. The procedure was repeated once.

d) Preparing the Cu-form of a zeolitic material having a framework structure type RTH

The H-form zeolitic material obtained from c) was ion-exchanged with 1 M Cu(CH₃COO)₂ aqueous solution at 50° C. for 2 hours and calcined at 550° C. for 4 hours.

Copper content (Cu) of the Cu-exchanged RTH zeolitic material: 2.7 weight-%, calculated as elemental Cu, based on the total weight of the zeolitic material. The thermal analysis TG-DTA of the respectively obtained fresh RTH zeolitic material is shown in FIG. 5. The XRD patterns of the respectively obtained fresh Cu-RTH zeolitic material and of the zeolitic material after ageing in air with 10 vol. % H₂O at 750° C. for 16 hours are essentially identical indicating that the zeolitic material of the invention is hydrothermally stable even after ageing at a temperature of 750° C. as illustrated by FIG. 8. The BET specific surface area of Cu-RTH, determined as described in Reference Example 1 b), being 511 m²/g and the N₂ micropore volume of 0.23 cm³/g for the Cu-RTH zeolitic material after ageing in air with 10 vol. % H₂O at 750° C. for 16 hours are essentially identical to the BET specific surface area and the N₂ micropore volume of the fresh Cu-RTH zeolitic material which are of 503 m²/g and 0.23 cm³/g, respectively.

Example 2: Preparation of a Zeolitic Material having a Framework Structure Type RTH (Varying the Crystallization Temperature and Duration)

a) Preparing a zeolitic material having a framework structure type RTH

Materials:

| | |
|---|---|
| Zeolite Y powder as used in Example 1 | 1 g |
| N-methyl-2,6-dimethylpyridinium hydroxide | 5.83 g |
| solution as obtained in Example 1 a) | |
| NaOH powder | 0.15 g |

1 g of zeolite Y was mixed with 5.83 g of N-methyl-2,6-dimethylpyridinium hydroxide solution (0.6 mol·L⁻¹) and stirred at room temperature for 2 hours. Then, 0.15 g of NaOH was added. The synthesis mixture was stirred again at room temperature for 2 hours. The synthesis mixture composition was 0.11 Na₂O:0.21 SDA:1.0 SiO₂:0.04Al₂O₃:17.8 H₂O. The term SiO₂ refers to the silicon comprised in the zeolite Y calculated as silica. The obtained mixture was then transferred in a Teflon-lined autoclave oven. The autoclave was sealed and the mixture crystallized at 180° C. under static state for 3 hours. After pressure release and cooling to room temperature, the obtained suspension was subjected to filtration. The filter cake was washed with deionized water and was then dried for 2 hours at a temperature of 100° C. 0.8 g of zeolitic material was obtained.

The SiO₂: Al₂O₃ molar ratio of the zeolitic material was of 17.8. The crystallinity of the sample was of 100%, determined as described in Reference Example 1 g), as shown in FIG. 10.

b) Preparing the H-form of a zeolitic material having a framework structure type RTH

The zeolitic material obtained from a) is ion-exchanged with a 1M NH₄NO₃ solution at 80° C. for 2 hours and calcined at 550° C. for 4 hours. The procedure was repeated once.

c) Preparing the Cu-form of a zeolitic material having a framework structure type RTH

The H-form zeolitic material obtained from b) was ion-exchanged with 1 M Cu(CH₃COO)₂ aqueous solution at 50° C. for 2 hours and calcined at 550° C. for 4 hours.

Copper content (Cu) of the Cu-exchanged RTH zeolitic material: 3.3 weight-%, calculated as elemental Cu, based on the total weight of the zeolitic material. The XRD patterns of the respectively obtained fresh Cu-RTH zeolitic material show the characteristic peaks of the RTH framework structure, namely a peak at around 10 2Theta, a peak at around 18 2Theta, a peak at around 23 2Theta, two peaks from 24.5 to 26 2Theta, a peak around 30 2Theta, wherein the peak at 18 2Theta and the two peaks from 24.5 to 26 2Theta exhibit the highest intensities, as shown in FIG. 11 (a). These peaks are characteristic of the RTH framework structure.

### Example 3: Preparation of a Zeolitic Material Having a Framework Structure Type RTH (Varying the Crystallization Temperature and Duration)

a) Preparing a zeolitic material having a framework structure type RTH

Materials:

| | |
|---|---|
| Zeolite Y powder as used in Example 1 | 1 g |
| N-methyl-2,6-dimethylpyridinium hydroxide | 5.85 g |
| solution as obtained in Example 1 a) | |
| NaOH powder | 0.15 g |

1 g of zeolite Y was mixed with 5.85 g of N-methyl-2,6-dimethylpyridinium hydroxide solution (0.6 mol·L⁻¹) and stirred at room temperature for 2 hours. Then, 0.15 g of NaOH powder was added. The synthesis mixture was stirred again at room temperature for 2 hours. The synthesis mixture composition was 0.11 Na₂O:0.21 SDA:1.0 SiO₂:0.04Al₂O₃:17.8 H₂O. The term SiO₂ refers to the silicon comprised in the zeolite Y calculated as silica. The obtained mixture was then transferred in a Teflon-lined autoclave oven. The autoclave was sealed and the mixture crystallized at 240° C. for 50 minutes under static state. After pressure release and cooling to room temperature, the obtained suspension was subjected to filtration. The filter cake was washed with deionized water and was then dried for 2 hours at a temperature of 100° C. 0.8 g of zeolitic material was obtained.

The SiO₂: Al₂O₃ molar ratio of the zeolitic material was of 17.7. The crystallinity of the sample was of 100%, determined as described in Reference Example 1 g), as shown in FIG. 12.

b) Preparing the H-form of a zeolitic material having a framework structure type RTH

The zeolitic material obtained a) is ion-exchanged with a 1M NH₄NO₃ solution at 80° C. for 2 hours and calcined at 550° C. for 4 hours. The procedure was repeated once.

c) Preparing the Cu-form of a zeolitic material having a framework structure type RTH

The H-form zeolitic material obtained from b) was ion-exchanged with 1 M Cu(CH₃COO)₂ aqueous solution at 50° C. for 2 hours and calcined at 550° C. for 4 hours.

Copper content of the Cu-exchanged RTH zeolitic material: 3.4 weight-%, calculated as elemental Cu, based on the total weight of the zeolitic material. The XRD patterns of the respectively obtained fresh Cu-RTH zeolitic material show a peak at around 10 2Theta, a peak at around 18 2Theta, a peak at around 23 2Theta, two peaks from 24.5 to 26 2Theta, a peak around 30 2Theta, wherein the peak at 18 2Theta and the two peaks from 24.5 to 26 2Theta exhibit the highest intensities, as shown in FIG. 11(b). These peaks are characteristic of the RTH framework structure.

Comparative Example 1: Preparation of a Zeolitic Material having a RTH-Type Framework Structure using an Organic Structure Directing Agent According to the Prior Art

a) Preparing an organic structure directing agent: 1,2,3-trimethylimidazolium hydroxide

0.1 mol of 1,2-dimethylimidazole and 0.1 mol of iodomethane (CH₃1) was dissolved in 20 g of ethanol. The mixture was stirred at room temperature for 48 hours in a dark place. The solvent and the excess of iodomethane were removed using rotary evaporation and the product was washed with ether. The structure was verified using ¹H NMR as shown in FIG. 14. Finally, the product was converted from the iodide form to the hydroxide form using anion exchange resin to obtain1,2,3-trimethylimidazolium hydroxide. 130 g of 1,2,3-trimethylimidazolium hydroxide were obtained.

b) Trying to prepare a zeolitic material having a framework structure type RTH

Materials:

| | |
|---|---|
| Zeolite Y powder as used in Example 1 | 1 g |
| 1,2,3-trimethylimidazolium hydroxide solution | 5.85 g |
| as obtained in a) (0.6 mol · L⁻¹) | |
| NaOH powder | 0.20 g |

1 g of zeolite Y was mixed with 5.85 g of 1,2,3-trimethylimidazolium hydroxide solution (0.6 mol·L⁻¹) and stirred at room temperature for 2 hours. Then, 0.20 g of NaOH was added. The synthesis mixture was stirred again at room temperature for 2 hours. The synthesis mixture composition was 0.15 Na₂O:0.21 SDA:1.0 SiO₂:0.04 Al₂O₃:17.8 H₂O. The term SiO₂ refers to the silicon comprised in the zeolite Y calculated as silica. The obtained mixture was then transferred in a Teflon-lined autoclave oven. The autoclave was sealed and the mixture is crystallized at 130° C. for 96 hours under static state. After pressure release and cooling to room temperature, the obtained suspension was subjected to filtration. The filter cake was washed with deionized water and was then dried for 2 hours at a temperature of 100° C. 0.8 g of zeolitic material was obtained.

The product obtained was a RTH zeolitic material having a SiO₂:Al₂O₃ molar ratio of 18. The XRD patterns of the respectively obtained fresh zeolitic material show a peak at around 10 2Theta, a peak at around 18 2Theta, a peak at around 23 2Theta, two peaks from 24.5 to 26 2Theta, a peak around 30 2Theta which is characteristic of RTH framework structure as shown in FIG. 15. After 12 hours of heating in the autoclave, there was no crystalline product contrary to Example 1 according to the invention as shown in FIG. 16. Thus, Comparative Example 1 demonstrates that the structure directing agent is an essential compound for reducing the synthesis time of a zeolitic material having a framework structure type RTH.

### Comparative Example 2: Attempt to Prepare a Zeolitic Material Having a Framework Structure Type RTH in the Absence of a Base

Materials:

| | |
|---|---|
| Zeolite Y powder as used in Example 1 | 1 g |
| N-methyl-2,6-dimethylpyridinium hydroxide | 5.83 g |
| solution as obtained in Example 1 a) | |

1 g of zeolite Y was mixed with 5.83 g of N-methyl-2,6-dimethylpyridinium hydroxide solution (0.6 mol·L⁻¹) and stirred at room temperature for 2 hours. The synthesis mixture composition was 0.21 SDA:1.0 SiO₂:0.04 Al₂O₃:18 H₂O. The term SiO₂ refers to the silicon comprised in the zeolite Y calculated as silica. The obtained mixture was then transferred in a Teflon-lined autoclave oven. The autoclave was sealed and the mixture crystallized at 130° C. for 24 hours under static state. After pressure release and cooling to room temperature, the obtained suspension was subjected to filtration. The filter cake was washed with deionized water and was then dried for 2 hours at a temperature of 100° C.

The product obtained was a zeolite Y. The XRD patterns of the respectively obtained zeolitic material show the characteristic peaks of zeolite Y, namely a peak at around 6 2Theta, a peak at around 16 2Theta, a peak at around 20 2Theta, a peak at around 23 2Theta, a peak around 27 2Theta, as shown in FIG. 17.

Comparative Example 2 shows that a base, in particular a strong base such as NaOH, is an essential compound for synthesizing a zeolitic material having a framework structure type RTH according to the present invention. In particular, conducting the reaction procedure without a strong base leads to no reaction.

Comparative Example 3: Attempt to Prepare a Zeolitic Material Having a Framework Structure Type RTH using a Different Molar Ratio of the Base to Silica

Materials:

| | |
|---|---|
| Zeolite Y powder as used in Example 1 | 1 g |
| N-methyl-2,6-dimethylpyridinium hydroxide | |
| solution as obtained in Example 1 a) | 5.83 g |
| NaOH powder | 0.25 g |

1 g of zeolite Y was mixed with 5.83 g of N-methyl-2,6-dimethylpyridinium hydroxide solution (0.6 mol·L⁻¹) and stirred at room temperature for 2 hours. Then, 0.25 g of NaOH powder was added. The synthesis mixture was stirred again at room temperature for 2 hours. The synthesis mixture composition was 0.18 Na₂O:0.21 SDA:1.0 SiO₂:0.04 Al₂O₃:18 H₂O. The term SiO₂ refers to the silicon comprised in the zeolite Y calculated as silica. The obtained mixture was then transferred in a Teflon-lined autoclave oven. The autoclave was sealed and the mixture crystallized at 130° C. for 24 hours under static state. After pressure release and cooling to room temperature, the obtained suspension was subjected to filtration. The filter cake was washed with deionized water and was then dried for 2 hours at a temperature of 100° C.

The product obtained was a mixture of zeolite Y and a RTH zeolitic material. The XRD patterns of the respectively obtained zeolitic material show characteristic peaks of RTH framework structure, namely a peak at around 10 2Theta, a peak at around 18 2Theta, a peak at around 23 2Theta, two peaks from 24.5 to 26 2Theta, a peak around 30 2Theta, and of zeolite Y, namely a peak at around 6 2Theta, a peak at around 16 2Theta, a peak at around 20 2Theta, a peak at around 23 2Theta, a peak around 27 2Theta, as shown in FIG. 18.

Comparative Example 3 shows that the amount of the base, such as NaOH, is essential for synthesizing a zeolitic material having a framework structure type RTH according to the present invention. In particular, conducting the reaction procedure at an amount of base, preferably NaOH, outside of the inventive range leads to a mixture of a RTH zeolitic material and starting material.

Comparative Example 4: Attempt to Prepare a Zeolitic Material Having a Framework Structure Type RTH without a Template

Materials:

| | |
|---|---|
| Zeolite Y powder as used in Example 1 | 1 g |
| NaOH powder | 0.15 g |
| Deionized water | |

1 g of zeolite Y was mixed with 0.15 g of NaOH in deionized water and stirred at room temperature for 2 hours. The synthesis mixture composition was 0.11 Na₂O:1.0 SiO₂:0.04 Al₂O₃:18 H₂O. The term SiO₂ refers to the silicon comprised in the zeolite Y calculated as silica. The obtained mixture was then transferred in a Teflon-lined autoclave oven. The autoclave was sealed and the mixture crystallized at 130° C. for 24 hours under static state. After pressure release and cooling to room temperature, the obtained suspension was subjected to filtration. The filter cake was washed with deionized water and was then dried for 2 hours at a temperature of 100° C.

The product obtained was amorphous. The XRD patterns of the respectively obtained product are characteristic of amorphous product as shown in FIG. 19.

Comparative Example 4 shows that a structure directing agent is an essential compound for synthesizing a zeolitic material having a framework structure type RTH according to the present invention. In particular, conducting the reaction procedure without a structure directing agent leads to amorphous products.

Comparative Example 5: Attempt to prepare a zeolitic material having a RTH-type framework structure using a different molar ratio of water to silica

Materials:

| | |
|---|---|
| Zeolite Y powder as used in Example 1 | 1 g |
| N-methyl-2,6-dimethylpyridinium hydroxide | 5.83 g |
| solution as obtained in Example 1 a) | |
| NaOH powder | 0.15 g |
| Deionized water | 20 g |

1 g of zeolite Y was mixed with 5.83 g of N-methyl-2,6-dimethylpyridinium hydroxide solution (0.6 mol·L⁻¹) in deionized water, 20 g of deionized water was added and stirred at room temperature for 2 hours. Then, 0.15 g of NaOH powder was added. The synthesis mixture was stirred again at room temperature for 2 hours. The synthesis mixture composition was 0.11 Na₂O: 0.21 SDA: 1.0 SiO₂:0.04 Al₂O₃:84.5 H₂O. The term SiO₂ refers to the silicon comprised in the zeolite Y calculated as silica. The obtained mixture was then transferred in a Teflon-lined autoclave oven. The autoclave was sealed and the mixture crystallized at 130° C. for 24 hours under static state. After pressure release and cooling to room temperature, the obtained suspension was subjected to filtration. The filter cake was washed with deionized water and was then dried for 2 hours at a temperature of 100° C.

The product obtained was a mixture of zeolite Y and a RTH zeolitic material. The XRD patterns of the respectively obtained zeolitic material show characteristic peaks of RTH framework structure and of zeolite Y, namely a peak at around 6 2Theta, a peak at around 16 2Theta, a peak at around 20 2Theta, a peak at around 23 2Theta, a peak around 27 2Theta, as shown in FIG. 20.

Comparative Example 5 shows that the amount of water is essential for synthesizing a zeolitic material having a framework structure type RTH according to the present invention. In particular, conducting the synthesis procedure with an amount of water outside of the inventive range leads to a mixture of a RTH zeolitic material and starting material.
Comparative Example 6: Attempt to Prepare a Zeolitic Material Having a Framework Structure Type RTH using a Zeolite Y Having a Different Molar Ratio of Silica to Alumina

Materials:

| | |
|---|---|
| Zeolite Y (USY) powder having a SiO₂: | 1 g |
| Al₂O₃ molar ratio of 12:1 | |
| N-methyl-2,6-dimethylpyridinium hydroxide | 5.83 g |
| solution as obtained in Example 1 a) | |
| NaOH powder | 0.15 g |

1 g of zeolite Y was mixed with 5.83 g of N-methyl-2,6-dimethylpyridinium hydroxide solution (0.6 mol·L⁻¹) in deionized water and stirred at room temperature for 2 hours. Then, 0.15 g of NaOH powder was added. The synthesis mixture was stirred again at room temperature for 2 hours. The synthesis mixture composition was 0.11 Na₂O: 0.14 SDA: 1.0 SiO₂:0.083 Al₂O₃:18 H₂O. The term SiO₂ refers to the silicon comprised in the zeolite Y calculated as silica. The obtained mixture was then transferred in a Teflon-lined autoclave oven. The autoclave was sealed and the mixture crystallized at 130° C. for 24 hours under static state. After pressure release and cooling to room temperature, the obtained suspension was subjected to filtration. The filter cake was washed with deionized water and was then dried for 2 hours at a temperature of 100° C.

The product obtained was a zeolite Y. The XRD patterns of the respectively obtained zeolitic material show the characteristic peaks of zeolite Y, namely a peak at around 6 2Theta, a peak at around 16 2Theta, a peak at around 20 2Theta, a peak at around 23 2Theta, a peak around 27 2Theta, as shown in FIG. 21.

Comparative Example 6 shows that the SiO₂:Al₂O₃ molar ratio of the starting material is essential for synthesizing a zeolitic material having a framework structure type RTH according to the present invention. In particular, conducting the reaction procedure, with a SiO₂:Al₂O₃ molar ratio outside of the inventive range, leads to no reaction.

Example 4: Use of the Zeolitic Material Having a Framework Structure Type RTH for Selectively Catalytically Reducing Nitrogen Oxides

Catalysts comprising the zeolitic materials respectively obtained from Examples 1, 2 and 3 were prepared and subjected to a selective catalytic reduction test by tableting and squash to 40-60 mesh. The amount of catalysts used in the fixed bed is 0.5 g each.

For this purpose, the catalytic activities of the respectively obtained fresh catalysts were measured with a fixed-bed quartz continuous reactor (the length of the reactor is 30 cm, and its internal diameter is 4 mm) in gaseous mixture containing 500 ppm of NO, 500 ppm of NH₃, 10% of 0₂ and N₂ as a balance gas. The gas hourly space velocity (GHSV) was 80 000 h⁻¹ at temperatures of the feed stream of 100 to 600° C. The inlet and outlet gases were monitored by FTIR (Nicolet iS50 equipped with 2 m gas cell and a DTGS detector, resolution: 0.5 cm⁻¹, OPD velocity: 0.4747 cm s⁻¹). The collected region was 600-4000 cm-1 and the number of scans per spectrum was 16 times. The results are displayed in FIG. 22.

The catalysts comprising the zeolitic material obtained from Examples 1 to 3 exhibit NOx conversions of greater than 90% across the temperature range of from 200 to 400° C. for the respectively obtained fresh catalysts. The respectively obtained fresh catalyst comprising a zeolitic material obtained from Example 1 (sample a in FIG. 22), a Cu-RTH with 2.7 weight-% Cu based on the weight of the zeolitic material calculated as elemental Cu exhibits a T50 of approximately 175° C., wherein T50 corresponds to the temperature at which 50% of NOx has been converted, and 100% conversion of NOx in the temperature range of from approximately 250 to 350° C.

After ageing at 750° C., the catalyst comprising a zeolitic material obtained from Example 1 (sample d in FIG. 22) exhibits a T₅₀ of approximately 260° C. higher than the T₅₀ of the fresh catalyst. This example thus demonstrates that the catalyst according to the invention may be active at low temperature. Further, without wanting to be bound by any theory it could be assumed that the lower NOx conversion compared to the fresh catalyst is due to dealumination of the Cu-RTH zeolitic material occurring during ageing. This dealumination is confirmed by FIG. 23 wherein a peak around 0 ppm is present corresponding to the presence of extra framework aluminum.

### Examples 5 to 10: Preparation of Zeolitic Materials Having a Framework Structure Type RTH

For preparing the RTH zeolitic materials of Examples 5 to 10, the process of Example 1 has been repeated except that the ratios outlined in Table 1 below have been applied.

TABLE 1
Synthesis compositions

| Examples | Na₂O/SiO₂ | SDA*/SiO₂ | H₂O/SiO₂ | Al₂O₃/SiO₂ |
|---|---|---|---|---|
| 5 | 0.04 | 0.21 | 18 | 0.04 |
| 6 | 0.14 | 0.21 | 18 | 0.04 |
| 7 | 0.11 | 0.14 | 18 | 0.04 |
| 8 | 0.11 | 0.36 | 18 | 0.04 |
| 9 | 0.11 | 0.21 | 4.5 | 0.04 |
| 10 | 0.11 | 0.21 | 44.5 | 0.04 |

*SDA = N-methyl-2,6-dimethylpyridinium hydroxide solution (0.6 mol · L⁻¹)

The respectively obtained materials were zeolitic materials having a framework structure RTH.

The XRD patterns of the respectively obtained material of Example 5 show the characteristic peaks of zeolite RTH, namely 10 2Theta, a peak at around 18 2Theta, a peak at around 23 2Theta, two peaks from 24.5 to 26 2Theta, a peak around 30 2Theta, as shown in FIG. 24.

The XRD patterns of the respectively obtained material of Example 6 show the characteristic peaks of zeolite RTH, namely 10 2Theta, a peak at around 18 2Theta, a peak at around 23 2Theta, two peaks from 24.5 to 26 2Theta, a peak around 30 2Theta, as shown in FIG. 25.

The XRD patterns of the respectively obtained material of Example 7 show the characteristic peaks of zeolite RTH, namely 10 2Theta, a peak at around 18 2Theta, a peak at around 23 2Theta, two peaks from 24.5 to 26 2Theta, a peak around 30 2Theta, as shown in FIG. 26.

The XRD patterns of the respectively obtained material of Example 8 show the characteristic peaks of zeolite RTH, namely 10 2Theta, a peak at around 18 2Theta, a peak at around 23 2Theta, two peaks from 24.5 to 26 2Theta, a peak around 30 2Theta, as shown in FIG. 27.

The XRD patterns of the respectively obtained material of Example 9 show the characteristic peaks of zeolite RTH, namely 10 2Theta, a peak at around 18 2Theta, a peak at around 23 2Theta, two peaks from 24.5 to 26 2Theta, a peak around 30 2Theta, as shown in FIG. 28.

The XRD patterns of the respectively obtained material of Example 10 show the characteristic peaks of zeolite RTH, namely 10 2Theta, a peak at around 18 2Theta, a peak at around 23 2Theta, two peaks from 24.5 to 26 2Theta, a peak around 30 2Theta, as shown in FIG. 29.

### BRIEF DESCRIPTION OF THE FIGURES

FIG. 1: shows ¹³C NMR of N-methyl-2,6-dimethylpyridine iodide obtained according to a) of Example 1.

FIG. 2: shows ¹H NMR of N-methyl-2,6-dimethylpyridine iodide obtained according to a) of Example 1.

FIG. 3A a: shows the XRD pattern of the respectively obtained zeolitic material according to b) of Example 1.

FIG. 3B a: shows the N₂ sorption isotherms of the respectively obtained fresh RTH zeolitic material according to b) of Example 1 illustrating that said material does not have any microporous adsorption and suggesting that the microporosity is fully filled with the organic template.

FIG. 3B b: shows the N₂ sorption isotherms of the RTH zeolitic material according to b) of Example 1 after calcination at 550° C. for 4 hours, these isotherms show a Lang-muir-type curve. The steep increasing occurring in the curve at a relative pressure of 10⁻⁶<P/Pₒ<0.01 is due to the filing of the micropores by N₂ which permits to calculate the BET specific surface area and the N₂ micropore volume.

FIGS. 3C a: shows the SEM image of the respectively obtained fresh RTH zeolitic material (low magnification: scale bar 2 micrometers) according to b) of Example 1.

FIG. 3D a: shows the SEM image of the respectively obtained fresh RTH zeolitic material (high magnification: scale bar 500 nm) according to b) of Example 1.

FIG. 4: shows the crystallization curve of the zeolitic material according to b) of Example 1

FIG. 5: shows the thermal analysis TG-DTA of the respectively obtained RTH zeolitic material according to Example 1. A major exothermic peak at 200-800° C. is displayed accompanied by a weight loss of 22.4%, which is related to the decomposition of the organic template molecules in the framework.

FIG. 6: shows the XRD patterns of the respectively obtained zeolitic material after a crystallization temperature of 3 h (a), 6 h (b), 9 h (c), 10 h (d), 11 h (e), 12 h (f)-according to b) of Example 1-, 15 h (g), 288 h (h) and 432 h (i). After 3 h of crystallization, the XRD pattern of the zeolitic material shows the characteristic peaks of zeolite Y, namely a high intensity peak around 6 (2Theta), a high intensity peak around 12 (2Theta), a high intensity peak around 16 (2Theta), a high intensity peak around 24 (2Theta) and a high intensity peak around 27 (2Theta). After 6 h of crystallization, the XRD pattern still shows peaks related to zeolite Y. After 9 h of crystallization, the XRD pattern shows peaks associated with the framework structure type RTH at 25 (2Theta). After 10 and 11 h of crystallization, the intensity of the peaks at 25 (2Theta) increases. After 12 h of crystallization, the XRD pattern shows the characteristic peaks of a RTH framework structure. Further, increasing the duration of crystallization to 288 h and 432 h does not change the intensity of the peaks of the XRD patterns associated with the framework structure type RTH. This illustrates that the zeolitic material having a framework structure type RTH obtained according to the invention has a high stability in the synthesis mixture.

FIG. 7: shows the SEM image of the respectively obtained zeolitic material after a crystallization temperature of 3 h (a), 6 h (b), 9 h (c), 10 h (d), 11 h (e), 12 h (f)-according to b) of Example 1-, 15 h (g), 288 h (h) and 432 h (i). After 9 h of crystallization, block-like crystals appear indicating the formation of zeolitic materials having a framework structure type RTH. After 10 to 12 h of crystallization, the number of crystals increases.

FIG. 8: shows the XRD patterns of the respectively obtained fresh Cu-RTH zeolitic material according to Example 1 (a) and after ageing in air with 10 vol. % H₂O at 750° C. for 16 hours (b).

FIG. 9: shows the N₂ sorption isotherms of the respectively obtained fresh Cu-RTH zeolitic material according to Example 1 (a) and after ageing in air with 10 vol. % H₂O at 750° C. for 16 hours (b), giving Langmuir-type curve. The isotherms for (b) are offset vertically by 20 cm³/g.

FIG. 10: shows the crystallization curve of the zeolitic material according to Example 2.

FIG. 11: shows the XRD patterns of the respectively obtained fresh Cu-RTH zeolitic material according to Example 2 (a) and according to Example 3 (b).

FIG. 12: shows the crystallization curve of the zeolitic material according to Example 3.

FIG. 13: shows ¹³C, ²⁷Al, and ²⁹Si MAS NMR of the respectively obtained RTH zeolitic materials according to b) of Example 1, i.e. before ion-exchange, and to a) of Examples 2 and 3, i.e. before ion-exchange, obtained at different temperatures, namely 130, 180 and 240° C. respectively.

FIG. 13A: shows the comparison of the ¹³C MAS NMR spectrum of the respectively obtained RTH zeolitic materials according to b) of Example 1, i.e. before ion-exchange, and to a) of Examples 2 and 3, i.e. before ion-exchange, with the liquid ¹³C NMR spectrum of 2,6-methyl-N-methylpridinium iodide. It is apparent that 2,6-methyl-N-methylpyridinium cations mostly exist in the channel of the zeolitic materials having a framework structure type RTH obtained at different temperatures, namely 130, 180 and 240° C. respectively.

FIG. 13B: shows the ²⁷Al MAS NMR spectrum of the respectively obtained RTH zeolitic materials according to b) of Example 1, i.e. before ion-exchange, and to a) of Examples 2 and 3, i.e. before ion-exchange. The materials give a sharp band at 59 ppm associated with tetrahedral coordinated aluminum species in the framework and the absence of a signal around zero ppm indicates that there is no extra framework Al species in the sample.

FIG. 13C: shows the ²⁹Si MAS NMR spectrum of the respectively obtained RTH zeolitic materials according to b) of Example 1, i.e. before ion-exchange, and to a) of Examples 2 and 3, i.e. before ion-exchange. The materials exhibit peaks at about −112.2, −107.7, and −102.1 ppm. The peaks at −112.2 and −107.7 ppm are assigned to Si (4Si) species, while the peak at -102.1 ppm is assigned to Si(3Si) species. The signal intensity of Si(3Si) species is of 9.3% at the synthesis temperature of 130° C., while the signal intensity of Si(3Si) species are of 6.3% and 4.2% at the synthesis temperature of 180 and 240° C., respectively. Considering the same Si/Al ratios in the products, the lower intensity of Si(3Si) species means the less amounts of structure defects.

FIG. 14: shows ¹H NMR of 1,2,3-trimethylimidazolium iodide obtained according to a) of Comparative Example 1.

FIG. 15: shows the XRD patterns of the respectively obtained fresh RTH zeolitic material obtained according to b) of Comparative Example 1.

FIG. 16: shows the crystallization curve of the zeolitic material according to comparative Example 1.

FIG. 17: shows the XRD patterns of the respectively obtained fresh zeolite Y obtained according to Comparative Example 2.

FIG. 18: shows the XRD patterns of the respectively obtained mixture of fresh zeolitic materials Y and RTH obtained according to Comparative Example 3.

FIG. 19: shows the XRD patterns of the amorphous product obtained according to Comparative Example 4.

FIG. 20: shows the XRD patterns of the respectively obtained mixture of fresh zeolitic materials Y and RTH obtained according to Comparative Example 5.

FIG. 21: shows the XRD patterns of the respectively obtained fresh zeolite Y obtained according to Comparative Example 6.

FIG. 22: shows the NOx conversions of catalysts comprising a zeolitic material according to Examples 1 (a), 2 (b) and 3 (c) respectively and of a catalyst comprising a zeolitic material according to Example 1 after ageing at 750° C. (d).

FIG. 23: shows the ²⁷Al MAS NMR spectrum of the catalyst comprising a zeolitic material according to Example 1.

FIG. 24: shows the XRD patterns of the respectively obtained fresh zeolite RTH obtained according to Example 5, Table 1.

FIG. 25: shows the XRD patterns of the respectively obtained fresh zeolite RTH obtained according to Example 6, Table 1.

FIG. 26: shows the XRD patterns of the respectively obtained fresh zeolite RTH obtained according to Example 7, Table 1.

FIG. 27: shows the XRD patterns of the respectively obtained fresh zeolite RTH obtained according to Example 8, Table 1.

FIG. 28: shows the XRD patterns of the respectively obtained fresh zeolite RTH obtained according to Example 9, Table 1.

FIG. 29: shows the XRD patterns of the respectively obtained fresh zeolite RTH obtained according to Example 10, Table 1.

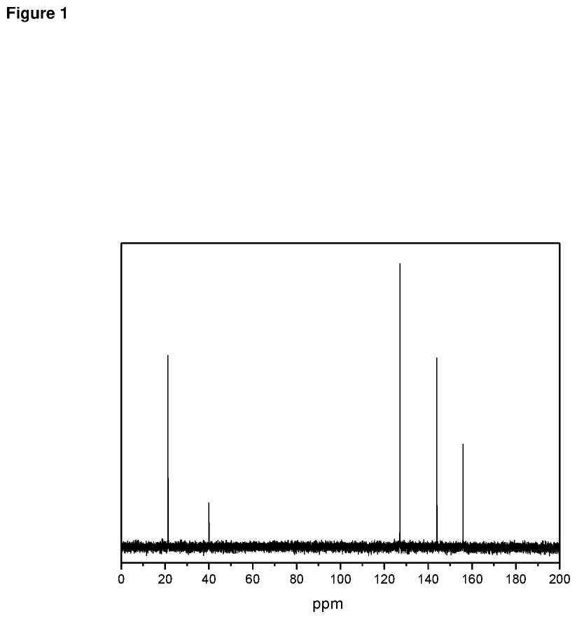

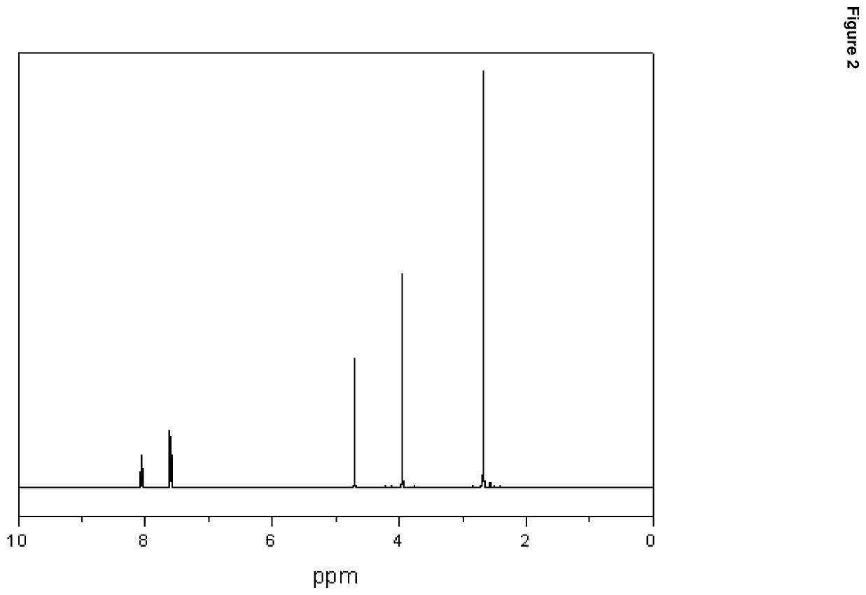

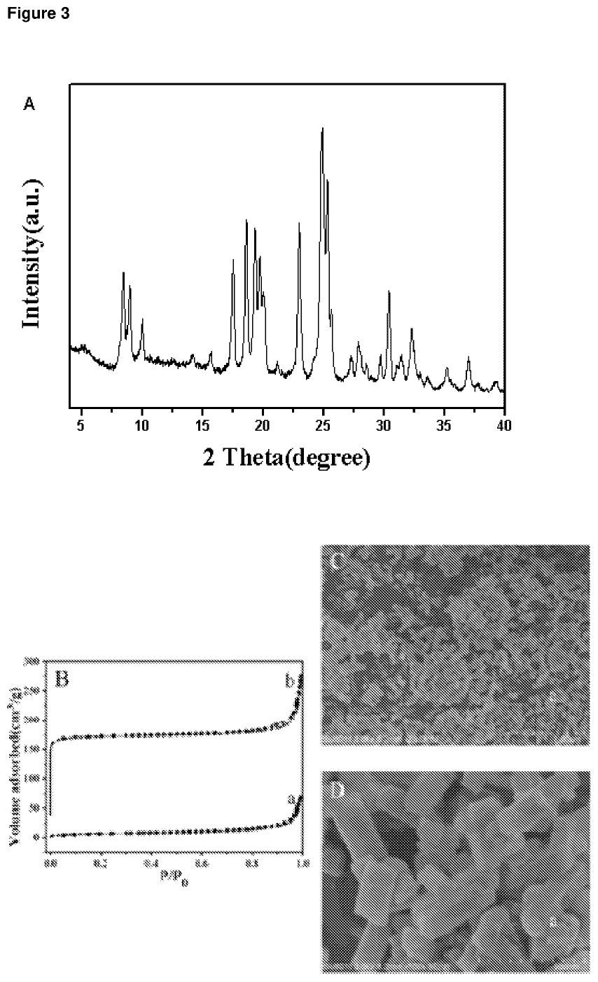

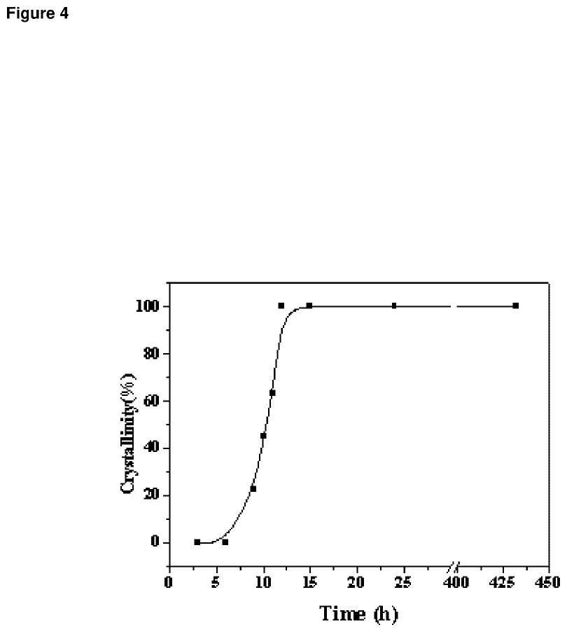

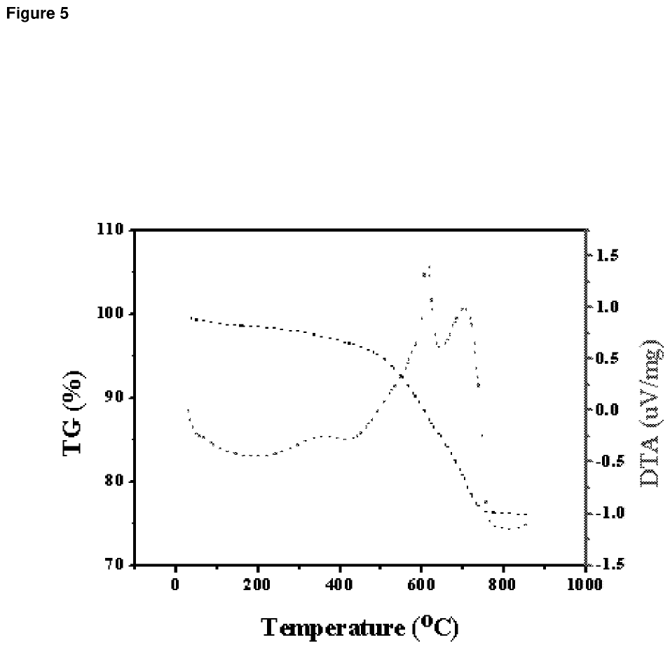

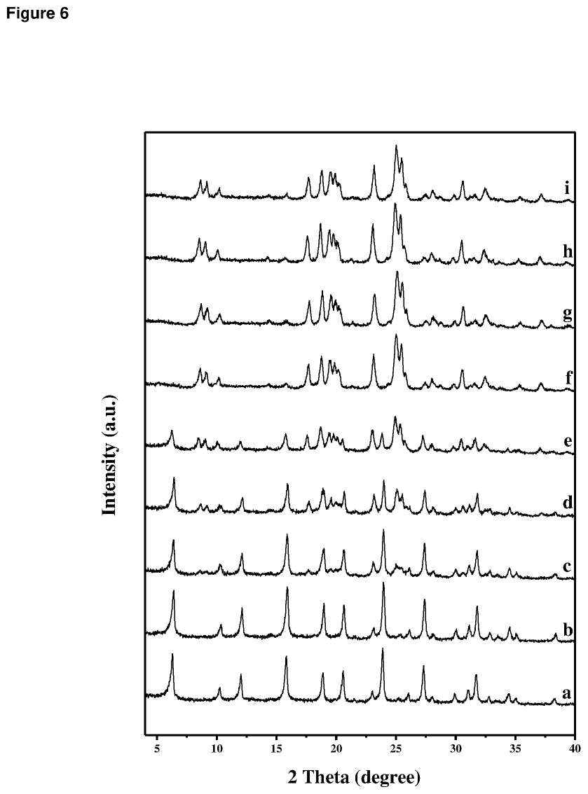

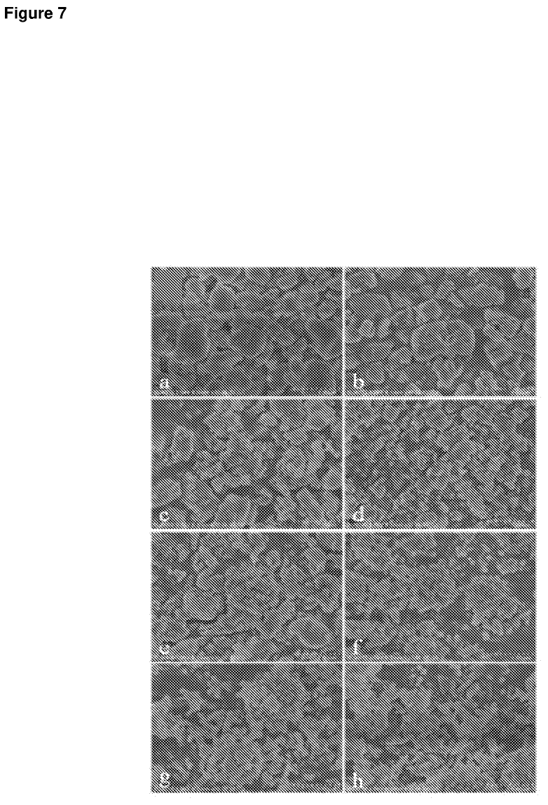

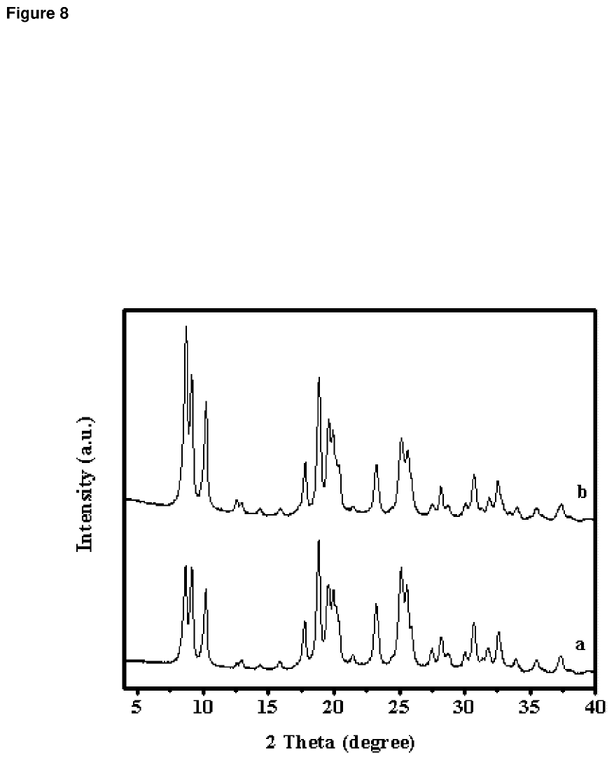

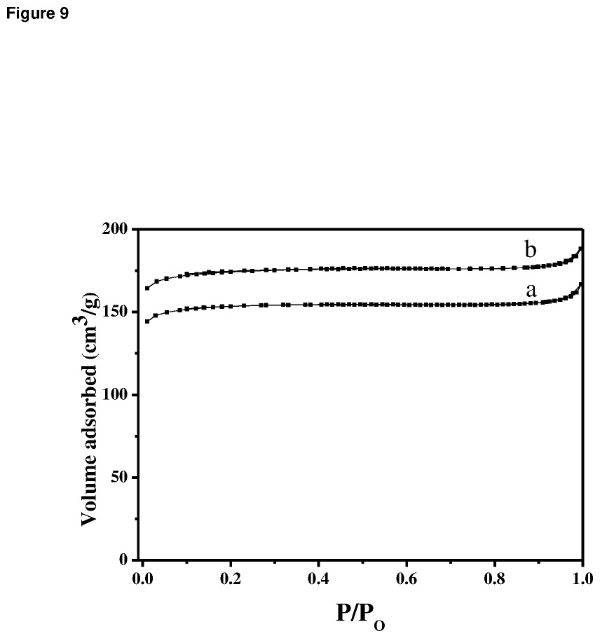

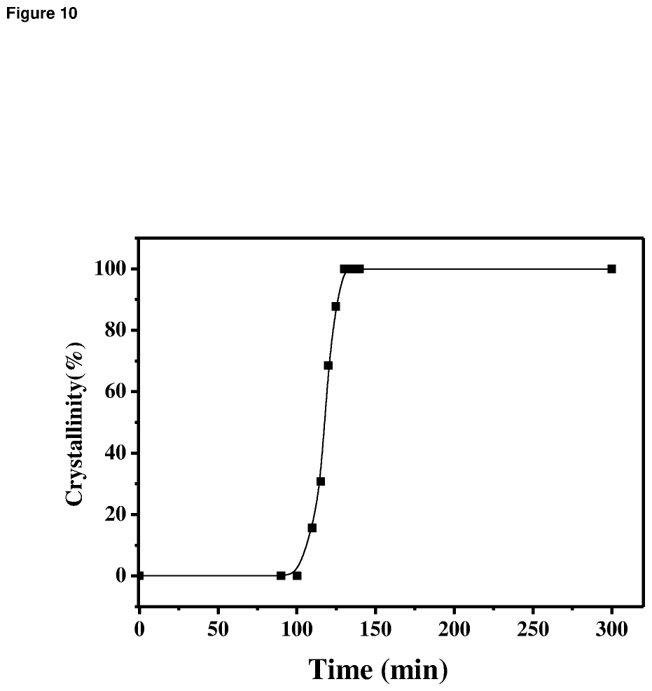

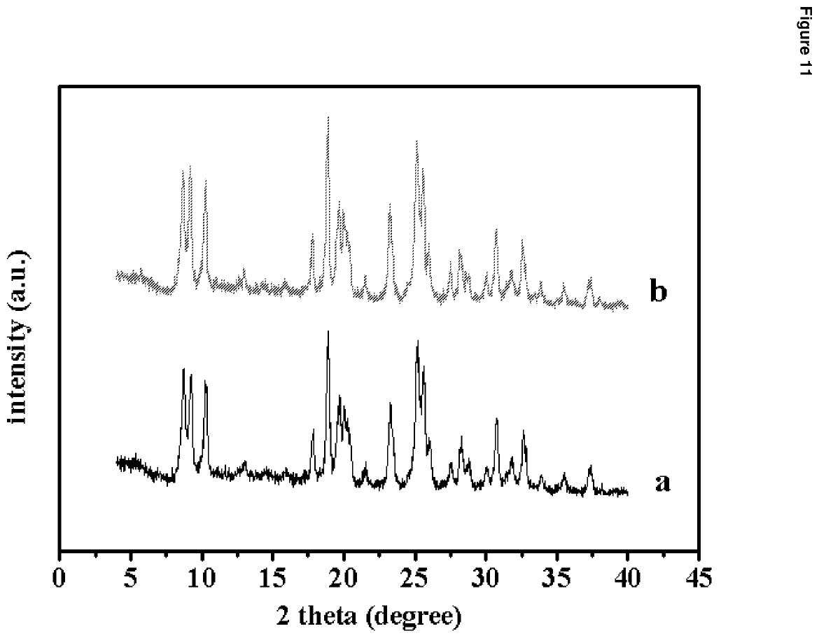

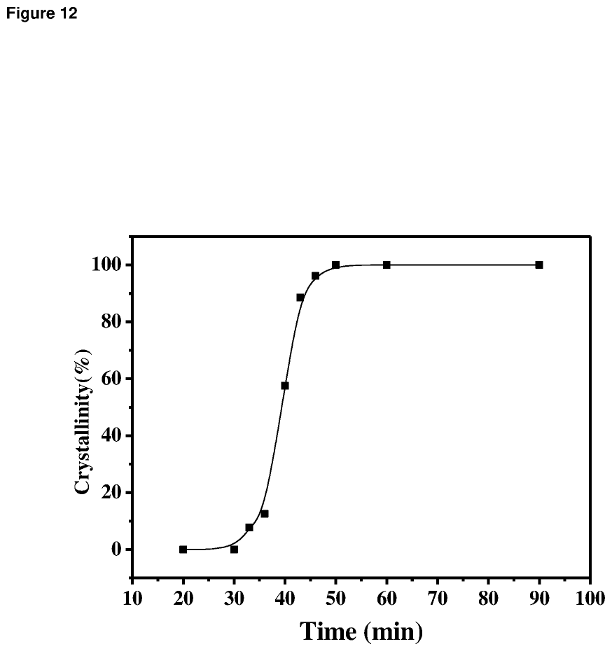

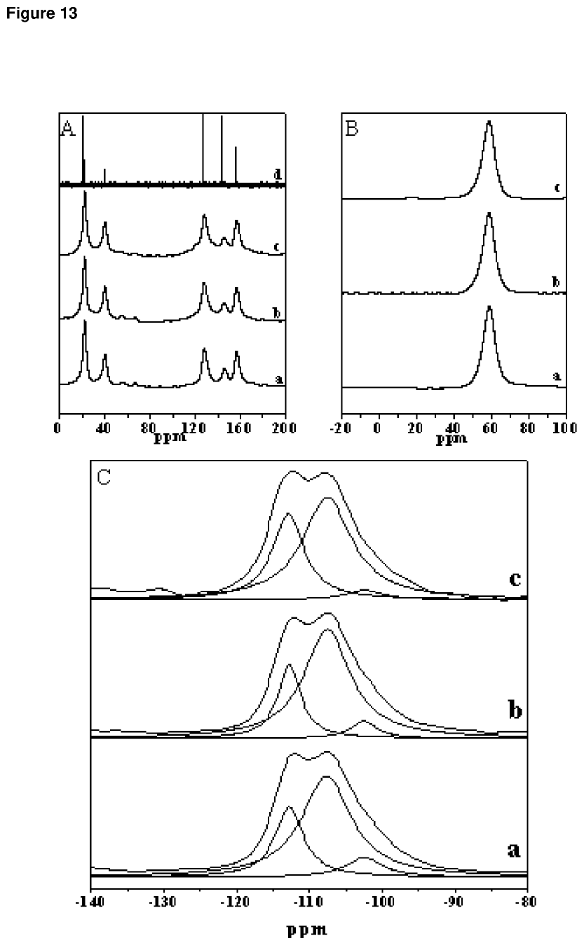

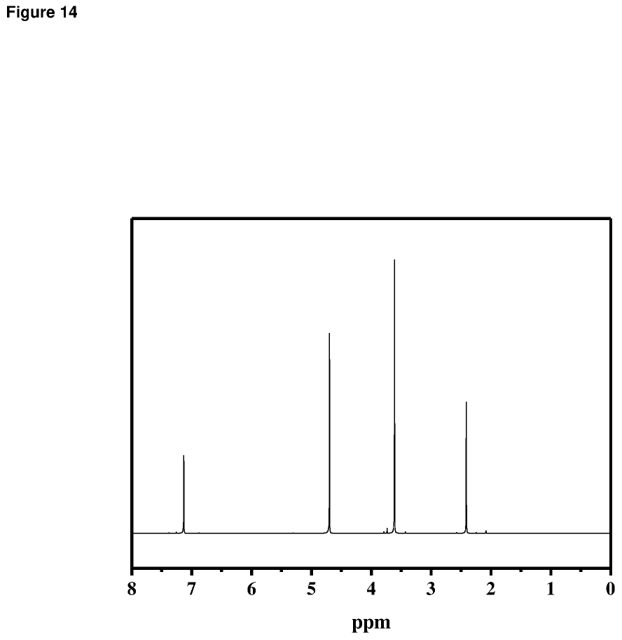

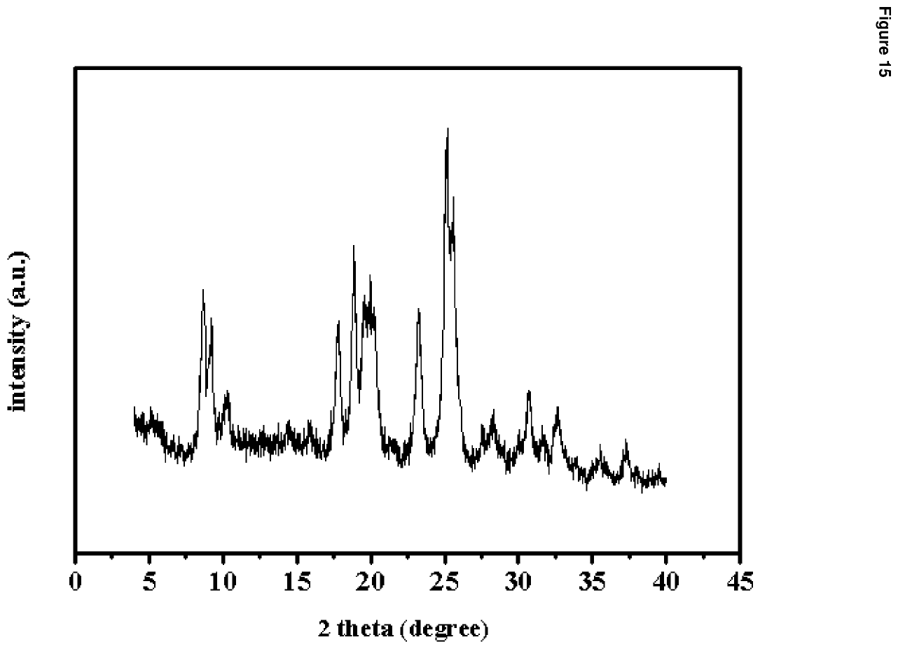

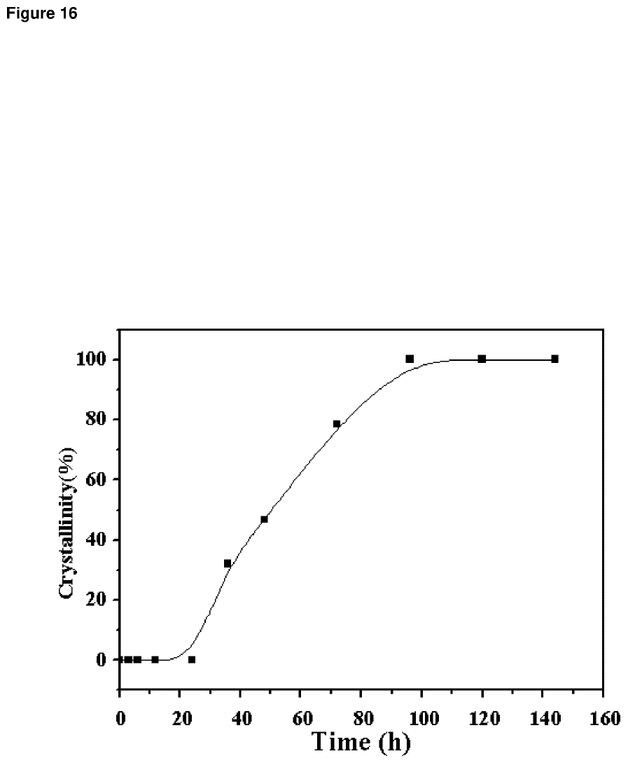

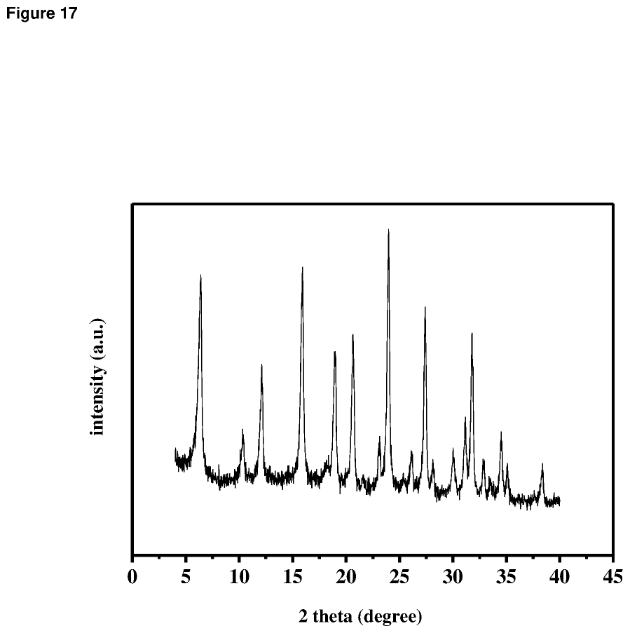

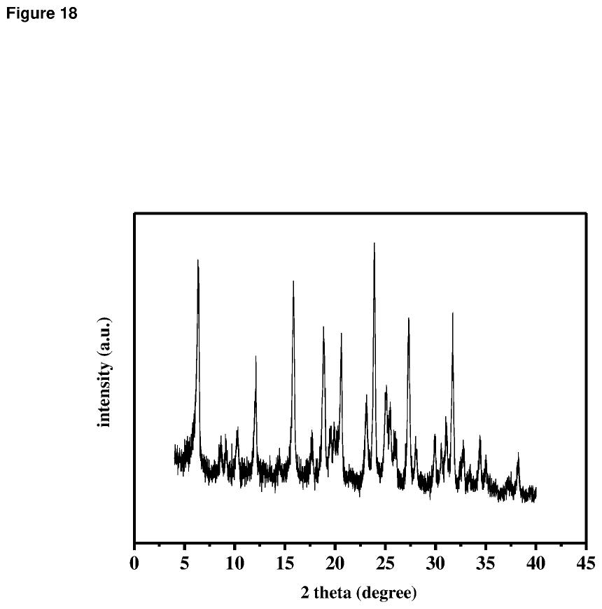

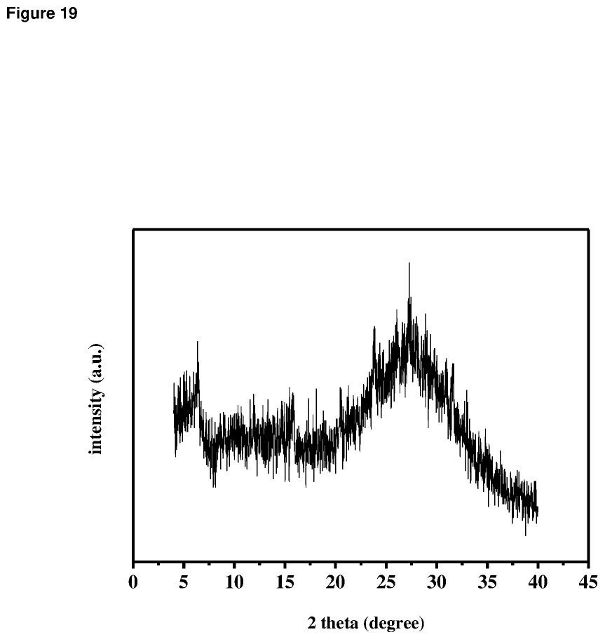

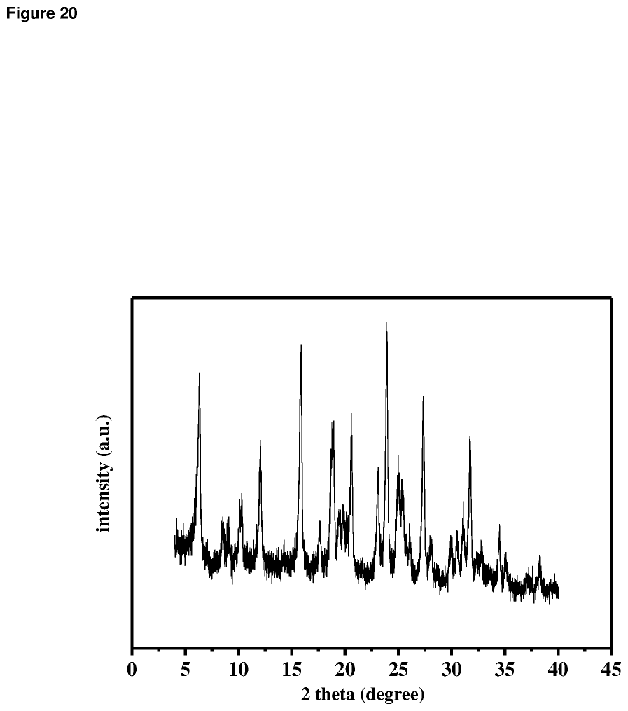

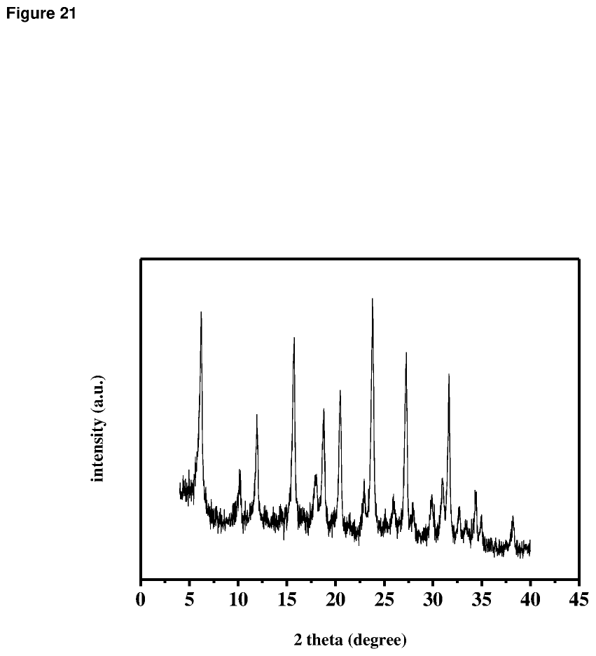

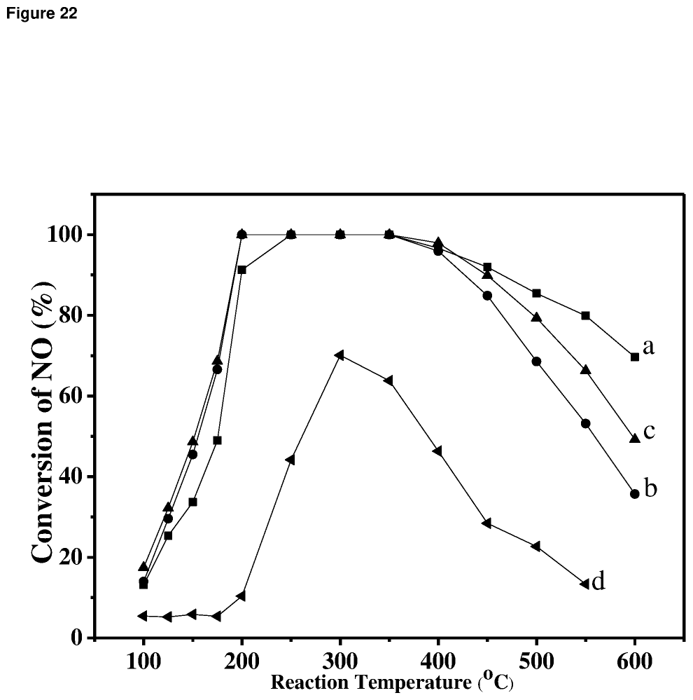

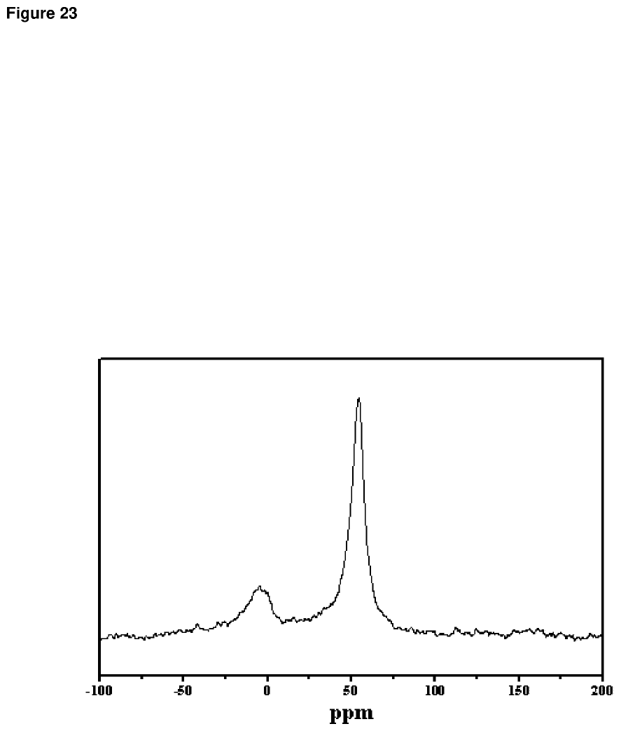

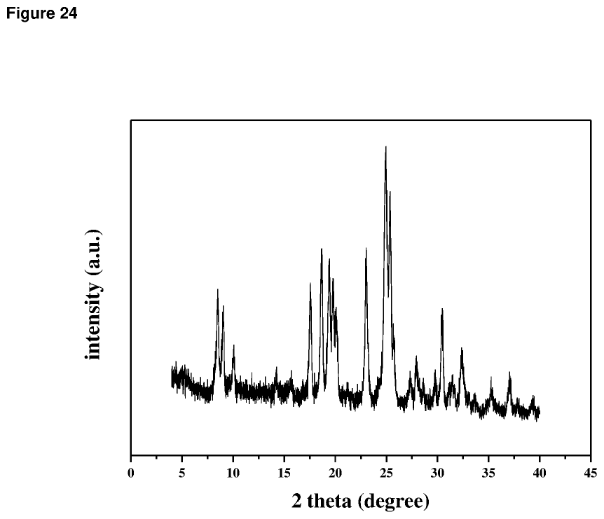

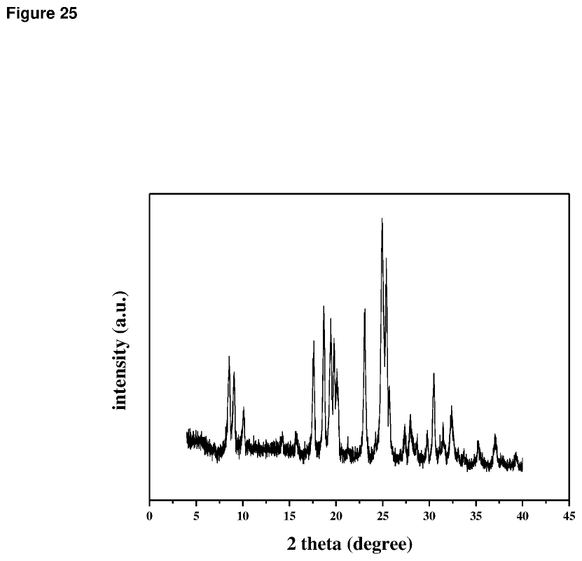

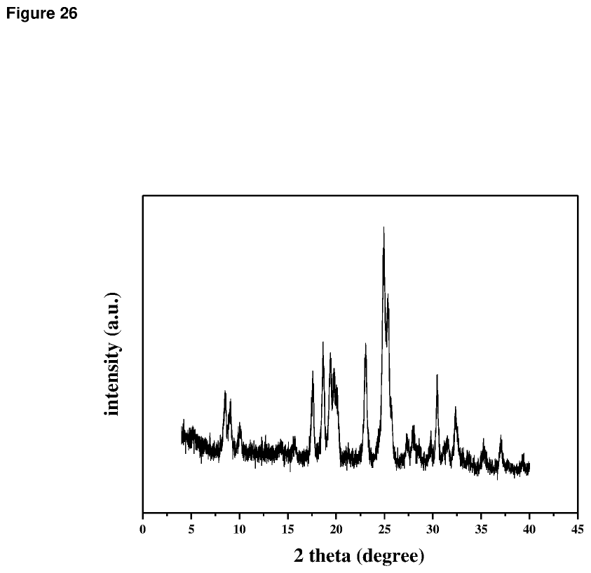

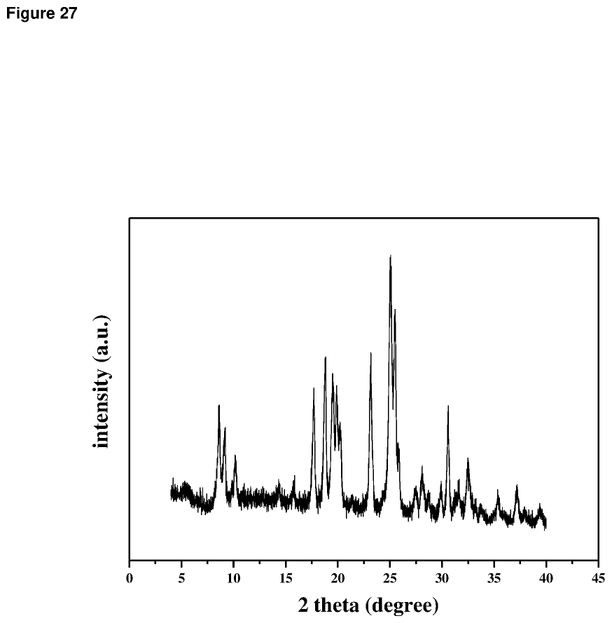

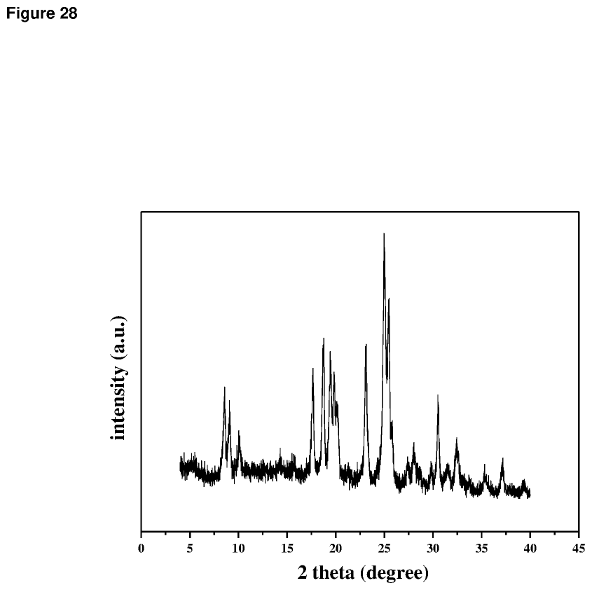

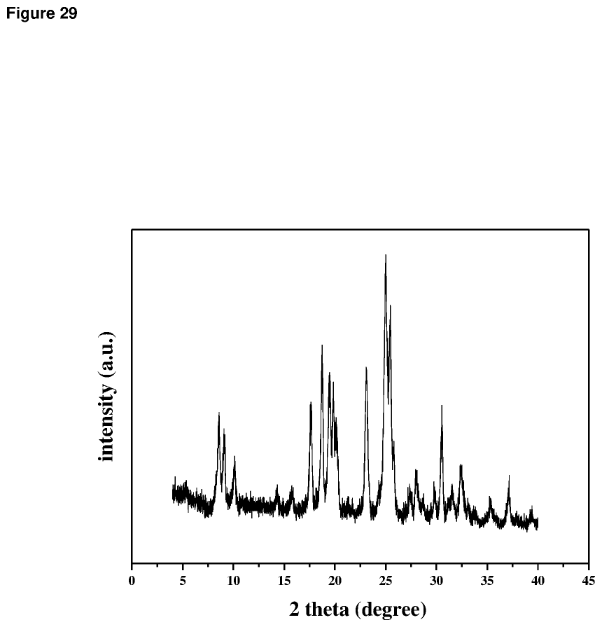

### CITED LITERATURE

Greg S. Lee et al., “Polymethylated [4.11] Octanes Leading to Zeolite SSZ_50”, Journal of Solid State Chemistry 167, p. 289-298 (2002)
Joel E. Schmidt et al., “Facile preparation of Aluminosilicate RTH across a wide composition range using a new organic structure-directing agent”, Chemistry of Materials (ACS Publications) 26, p. 7099-7105 (2014)
US 2017/0050858 A1

1. A process for preparing a zeolitic material having a framework structure type RTH and having a framework structure comprising a tetravalent element Y, a trivalent element X, and oxygen, the process comprising:
subjecting to hydrothermal crystallization conditions, a synthesis mixture comprising a zeolitic material having a FAU framework structure and having a framework structure comprising the tetravalent element Y, the trivalent element X, and oxygen, water, a source of a base, and an RTH framework structure directing agent comprising a N-methyl-2,6-dimethylpyridinium cation-comprising compound, to obtain the zeolitic material having an RTH framework structure,
wherein Y is Si, Sn, Ti, Zr, and/or Ge, and
wherein X is Al, B, In, and/or Ga.

2. The process of claim 1, wherein the N-methyl-2,6-dimethylpyridinium cation comprising compound is a salt.

3. The process of claim 1, wherein Y is Si.

4. The process of claim 1, wherein the zeolitic material having a framework structure type FAU is faujasite, zeolite Y, zeolite X, LSZ-210, US Y, or a mixture of two or more thereof.

5. The process of claim 1, wherein, in the synthesis mixture, a molar ratio of H₂O relative to Y, calculated as H₂O:YO₂, is in a range of from 2:1 to 80:1.

6. The process of claim 1, wherein in the synthesis mixture, a molar ratio of the structure directing agent relative to Y, calculated as structure directing agent: YO₂, is in a range of from 0.09:1 to 1:1.

7. The process of claim 1, wherein in the synthesis mixture, a molar ratio of the source of a base relative to Y, calculated as a source of a base: YO₂, is in a range of from 0.02:1 to 0.32:1.

8. The process of claim 1, wherein the source of a base comprises a hydroxide.

9. The process of claim 1, wherein the synthesis mixture is prepared by a process comprising:
preparing a mixture comprising a zeolitic material having a FAU framework structure and having a framework structure comprising the tetravalent element Y, the trivalent element X, and oxygen, water, and an RTH framework structure directing agent comprising a N methyl-2,6-dimethylpyridinium cation-comprising compound;
adding a source of a base to the mixture obtained in the preparing, to the synthesis mixture.

10. The process of claim 1, wherein the hydrothermal crystallization conditions comprise a crystallization duration in a range of from 10 minutes to 20 hours.

11. The process of claim 1, wherein during hydrothermal crystallization, the synthesis mixture is not stirred.

12. The process of claim 1, further comprising:
optionally, cooling the mixture obtained in the subjecting;
separating the zeolitic material from the mixture obtained from
the subjecting or the cooling;
optionally, subjecting the zeolitic material obtained from the separating to ion-exchange conditions.

13. The process of claim 12, comprising the subjecting the zeolitic material obtained from the separating to the ion-exchange conditions, which subjecting comprises
subjecting the zeolitic material obtained from the separating to the ion-exchange conditions comprising bringing a solution comprising ammonium ions in contact with the zeolitic material obtained from the separating, to obtain a zeolitic material having an RTH framework structure in its ammonium form;
calcining the zeolitic material in its ammonium form in a gas atmosphere, to obtain an H-form of the zeolitic material;
optionally subjecting the H form to ion-exchange conditions comprising bringing a solution comprising ions of one or more transition metals; and
calcining the H form, optionally after ion-exchange, in a gas atmosphere.

14. A zeolitic material having an RTH framework structure and having a framework structure comprising a tetravalent element Y, a trivalent element X, and oxygen,
wherein Y is Si, Sn, Ti, Zr, and/or Ge, and
wherein X is Al, B, In, and/or Ga.

15. The zeolitic material of claim 14, wherein in the framework structure of the zeolitic material, a molar ratio of Y:X, calculated as a YO₂: X₂O₃, is in the range of from 2: 1 to 25:1.

16. The zeolitic material of claim 14, having a BET specific surface area in a range of from 100 to 800 m²/g, and/or having a N₂ micropore volume in a range of from 0.05 to 0.60 cm³/g.

17. The zeolitic material of claim 14, having an X-ray diffraction pattern comprising reflections with Cu K (α1):
a first diffraction angle 2θ in a range of from 8.16 to 12.16° at an intensity in a range of from 20 to 40%;
a second diffraction angle 2θ in a range of from 16.86 to 20.86° at an intensity in a range of from 50 to 80%;
a third diffraction angle 2θ in a range of from 21.24 to 25.24° at an intensity in a range of from 52 to 82%;
a fourth diffraction angle 2θ in a range of from 23.10 to 27.10° at an intensity in a range of from 70 to 100%;
a fifth diffraction angle 2θ in a range of from 23.55 to 27.55° at an intensity in a range of from 70 to 100%; and
a sixth diffraction angle 2θ in a range of from 28.63 to 32.63° at an intensity in a range of from 30 to 50%,
wherein 100% relates to the intensity of a maximum peak in the X-ray powder diffraction pattern.

18. The zeolitic material of claim 14, additionally comprising a transition metals.

19. The zeolitic material of claim 18, having a BET specific surface area in a range of from 100 to 800 m²/g, and/or having a N₂ micropore volume in a range of from 0.05 to 0.60 cm³/g.

20. A catalytically active material, catalyst, or catalyst component, comprising the zeolitic material of claim 14.
